(19) United States
(12) Patent Application Publication
(10) Pub. No.: US 2025/0127174 A1
(43) Pub. Date: Apr. 24, 2025

(54) FORMULATIONS FOR ANTIMICROBIAL THERMOSET COATINGS

(71) Applicant: CORNING INCORPORATED, CORNING, NY (US)

(72) Inventors: Bavani Balakrisnan, Corning, NY (US); Xiaole Cheng, Painted Post, NY (US); Todd Patrick Egan, Horseheads, NY (US); Insik Jeon, Novi, MI (US); Weijun Niu, Painted Post, NY (US)

(21) Appl. No.: 18/687,557

(22) PCT Filed: Aug. 30, 2022
(86) PCT No.: PCT/US2022/041986

§ 371 Date: Feb. 28, 2024

Related U.S. Application Data
(60) Provisional application No. 63/240,596, filed on Sep. 3, 2021.

(51) Int. Cl. A01N 59/20; A01N 25/10; A01N 33/12; A01N 43/50; A01N 55/00; A01P 1/00

(52) U.S. Cl. CPC A01N 59/20; A01N 25/10; A01N 33/12; A01N 43/50; A01N 55/00; A01P 1/00

(57) ABSTRACT

Antimicrobial thermoset coating formulations including an additive compound and a thermo- or UV-curable resin are provided, especially where the additive is chosen from 1-butyl-3-methylimidazolium bromide, didecyldimethyl ammonium chloride, 1-cetylpyridinium chloride, hydroxyethylcellulose, carboxy methylcellulose, triethyl citrate, N-octadecyldimethyl-(3-(trimethoxysilyl)propyl)ammonium chloride, 4-(trimethoxysilylethyl)benzyltrimethylammonium chloride, N-[3-(trimethoxysilyl) propyl]-N,N,N-trimethylammonium chloride, dimethylbenzalkonium. Antimicrobial thermoset coating formulations further including a copper-containing material or cuprous oxide are provided. Methods of making the antimicrobial thermoset coating formulations are also provided. Methods for using the antimicrobial thermoset coating formulations are also provided. Antimicrobial systems are also provided.

### CROSS-REFERENCE TO RELATED APPLICATIONS

This application claims the benefit of priority under 35 U.S.C. § 119 of U.S. Provisional Application No. 63/240,596, filed Sep. 3, 2021, the content of which is incorporated herein by reference in its entirety.

### TECHNICAL FIELD

The present disclosure relates to formulations. More particularly, the disclosure relates to formulations for antimicrobial thermoset coatings that provide for synergistically increased antimicrobial efficacy.

### BACKGROUND

Antimicrobial polymer ultraviolet (“UV”) coatings have been used in a broad variety of applications that require both strong antimicrobial efficacy and mechanical durability.

Coatings or compositions including inorganic materials including copper, have been shown to provide strong antibacterial and antiviral protection, including against novel coronavirus COVID-19.

Generally, relatively high loading of a copper-containing material has been necessary to achieve strong antimicrobial properties. Such high loading may adversely affect the mechanical properties of the coatings, as well as demand a higher cost premium.

Thus, there is a need for materials that have sufficient biocidal activity while maintaining the mechanical properties of the coatings or compositions. Further, there is a need to for materials and additives that that are compatible in formulations with copper-based materials and compatible with thermal and UV curing techniques.

### SUMMARY

In an example, the present disclosure provides an antimicrobial thermoset coating formulation. The antimicrobial thermoset coating formulation includes: a copper-containing material in an amount from up to 0.1 to 30 weight %; an additive compound in an amount from up to 0.1 to 20 weight %; and a thermo- or UV-curable resin in an amount to total 100 weight % for the formulation. In certain examples, the copper-containing material may be cuprous oxide and/or cupric oxide. In other examples, the additive compound may be a compound of formulae (I), (II), (III), (IV), (V), (VI), or (VII):

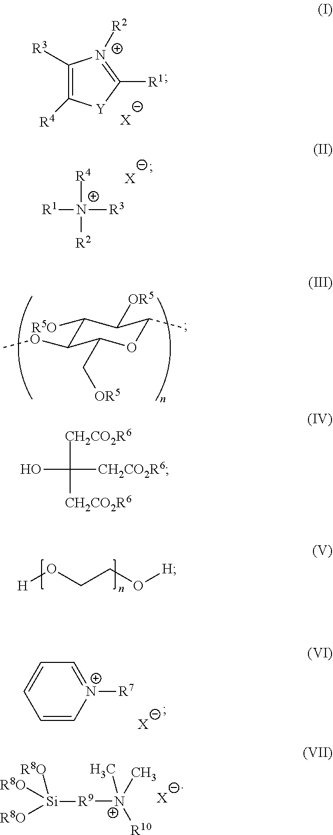

In still other examples, the additive compound may be 1-butyl-3-methylimidazolium bromide, didecyldimethyl ammonium chloride, 1-cetylpyridinium chloride, hydroxyethyl cellulose, carboxymethyl cellulose, triethyl citrate, N-octadecyldimethyl-(3-(trimethoxysilyl)propyl)ammonium chloride, 4-(trimethoxysilylethyl)benzyltrimethylammonium chloride, N-[3-(Trimethoxysilyl)propyl]-N,N,N-trimethylammonium chloride, and/or a benzalkonium chloride of the formula:

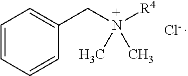

In still other examples, the thermo- or UV-curable resin may be selected from the group consisting of polyacrylate, polyurea, polyurethane, aliphatic and aromatic urethanes, polyurea/polyurethane hybrids, urea-formaldehyde foam, diallylphthalate, polyimide, polyamide, bismaleimides, polyolefin, polystyrene, polycarbonate, polyethylene terephthalate, polybutylene terephthalate, polyvinyl chloride, acrylonitrile butadiene styrene, benzoxazines, fluoropolymers, epoxy, phenolic resins, benzoxazines hybridized with epoxy and phenolic resins, melamine resins, polyesters, silicone resins, cyanate esters or polycyanurates, furan resins, vinyl ester resins, monomers thereof, oligomers thereof, polymers thereof, and any combination or blend thereof.

In another example, the present disclosure provides a method of preparing an antimicrobial thermoset coating formulation. The method includes: adding from up to 0.1 to 20 weight % of an additive compound to a thermo- or UV-curable resin in an amount to total 100 weight % for the formulation to provide a dispersion; agitating the dispersion; applying the dispersion to a surface of a substrate until the dispersion coats the surface of the substrate; and curing the film with a UV lamp to provide the antimicrobial thermoset coating formulation. In certain examples, the method may further include adding a copper-containing material in an amount from up to 0.1 to 30 weight % to the thermo- or UV-curable resin prior to the adding of the additive compound. In other examples, the copper-containing material may be cuprous oxide. In still other examples, the additive compound may be a compound of formulae (I), (II), (III), (IV), (V), (VI), or (VII). In still other examples, the additive compound may be selected from the group consisting of 1-butyl-3-methylimidazolium bromide, didecyldimethyl ammonium chloride, hydroxyethyl cellulose, carboxymethyl cellulose, triethyl citrate, 1-cetylpyridinium chloride, N-octadecyldimethyl-(3-(trimethoxysilyl)propyl)ammonium chloride, N-[3-(Trimethoxysilyl)propyl]-N,N,N-trimethylammonium chloride, 4-(trimethoxysilylethyl)benzyltrimethylammonium chloride, and a benzalkonium chloride of the formula:

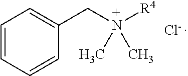

In still other examples, the thermo- or UV-curable resin may be selected from the group consisting of polyacrylate, polyurea, polyurethane, aliphatic and aromatic urethanes, polyurea/polyurethane hybrids, urea-formaldehyde foam, diallylphthalate, polyimide, polyamide, bismaleimides, polyolefin, polystyrene, polycarbonate, polyethylene terephthalate, polybutylene terephthalate, polyvinyl chloride, acrylonitrile butadiene styrene, benzoxazines, fluoropolymers, epoxy, phenolic resins, benzoxazines hybridized with epoxy and phenolic resins, melamine resins, polyesters, silicone resins, cyanate esters or polycyanurates, furan resins, vinyl ester resins, monomers thereof, oligomers thereof, polymers thereof, and any combination or blend thereof.

In yet another example, the present disclosure provides an antimicrobial system. The antimicrobial system includes: a reservoir including a dispersion of an antimicrobial thermoset coating formulation; a disperser fluidly connected to the reservoir configured to apply the antimicrobial thermoset coating formulation to a surface; and a heat or ultraviolet radiation source configured to cure the antimicrobial thermoset coating formulation after the antimicrobial thermoset coating formulation is applied to the surface; wherein the antimicrobial thermoset coating formulation includes: an additive compound in an amount from up to 0.1 to 20 weight %; a copper-containing material in an amount from up to 0.1 to 30 weight %; and a thermo- or UV-curable resin in an amount to total 100 weight % for the formulation. In certain examples, the copper-containing material may be cuprous oxide. In other examples, the additive compound may be a compound of formulae (I), (II), (III), (IV), (V), (VI), or (VII). In still other examples, the additive compound may be selected from the group consisting of 1-butyl-3-methylimidazolium bromide, didecyldimethyl ammonium chloride, hydroxyethyl cellulose, carboxymethyl cellulose, triethyl citrate, 1-cetylpyridinium chloride, N-octadecyldimethyl-(3-(trimethoxysilyl)propyl)ammonium chloride, N-[3-(Trimethoxysilyl)propyl]-N,N,N-trimethylammonium chloride, 4-(trimethoxysilylethyl)benzyltrimethylammonium chloride, and a benzalkonium chloride of the formula:

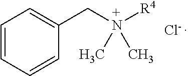

In still other examples, the thermo- or UV-curable resin may be selected from the group consisting of polyacrylate, polyurea, polyurethane, aliphatic and aromatic urethanes, polyurea/polyurethane hybrids, urea-formaldehyde foam, diallylphthalate, polyimide, polyamide, bismaleimides, polyolefin, polystyrene, polycarbonate, polyethylene terephthalate, polybutylene terephthalate, polyvinyl chloride, acrylonitrile butadiene styrene, benzoxazines, fluoropolymers, epoxy, phenolic resins, benzoxazines hybridized with epoxy and phenolic resins, melamine resins, polyesters, silicone resins, cyanate esters or polycyanurates, furan resins, vinyl ester resins, monomers thereof, oligomers thereof, polymers thereof, and any combination or blend thereof.

### DRAWINGS

In order that the present disclosure may be well understood, there will now be described various forms thereof, given by way of example, reference being made to the accompanying drawings. The components in the figures are not necessarily to scale. Moreover, in the figures, like-referenced numerals designate corresponding parts throughout the different views.

FIG. 1 illustrates a bar graph plot of antimicrobial log-kill for Comparative Examples 1-2 and Examples 1-31;

FIG. 1A illustrates an exploded view of FIG. 1 including the bar graph plot of antimicrobial log-kill for Comparative Examples 1-2 and Examples 1-10;

FIG. 1B illustrates an exploded view of FIG. 1 including the bar graph plot of antimicrobial log-kill for Comparative Examples 1-2 and Examples 11-20;

FIG. 1C illustrates an exploded view of FIG. 1 including the bar graph plot of antimicrobial log-kill for Comparative Examples 1-2 and Examples 21-31;

FIG. 2 illustrates a photograph of an antimicrobial thermoset coating formulation including 30 wt. % copper-containing material prepared according to Comparison Example 2 of the present disclosure;

FIG. 3 illustrates a photograph of an antimicrobial thermoset coating including 2 wt. % copper-containing material prepared according to Example 16 of the present disclosure; and

FIGS. 4A, 4B, 4C, and 4D illustrate microscope surface images of antimicrobial thermoset coatings including 100-μm scale bars, prepared according to Examples 16, 19, 20, and 21, respectively.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

In describing elements of the present disclosure, the terms “1^{st},” “2^{nd},” “first,” “second,” “A,” “B,” (a),” “(b),” and the like may be used herein. These terms are only used to distinguish one element from another element, but do not limit the corresponding elements irrespective of the nature or order of the corresponding elements.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

As used herein, the term “antimicrobial” means a material or surface that kills or inhibits the growth of microbes including bacteria, viruses, mildew, mold, algae, and/or fungi. The term antimicrobial does not mean the material or surface kills or inhibits the growth of all of such families of microbes or all species of microbes within such families, but that the material or surface kills or inhibits the growth of one or more species of microbes from one or more of such families.

As used herein, the term “biocidal” means a material with an active substance that is intended to destroy, deter, render harmless, prevent the action of, or otherwise exert a controlling effect on undesired organisms such as bacteria, viruses, mildew, mold, algae, and/or fungi.

As used herein, the term “logarithmic reduction” means the negative value of log(Ca/C0), where Ca is the colony form unit (CFU) number of the antimicrobial surface and C0 is the CFU number of the control surface that is not an antimicrobial surface. As an example, a 3 logarithmic reduction equals about 99.9% of the microbes killed and a 5 logarithmic reduction equals about 99.999% of microbes killed. The logarithmic reduction can be measured according to the procedures outlined in the United States Environmental Protection Agency Office of Pesticide Programs Protocol for the Evaluation of Bactericidal Activity of Hard, Non-porous Copper Containing Surface Products, dated 29 Jan. 2016.

The uses of the terms “a” and “an” and “the” and similar references in the context of describing the present disclosure (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

As used herein, the terms “comprise(s),” “include(s),” “having,” “has,” “can,” “contain(s),” and variants thereof, are intended to be open-ended transitional phrases, terms, or words that do not preclude the possibility of additional acts, structures, elements, or components. The present description also contemplates other embodiments “comprising,” “consisting of,” and “consisting essentially of,” the examples or elements presented herein, whether explicitly set forth or not.

As used herein, the term “about,” when used in the context of a numerical value or range set forth means a variation of ±15%, or less, of the numerical value. For example, a value differing by ±15%, ±14%, +10%, or ±5%, among others, would satisfy the definition of “about,” unless more narrowly defined in particular instances.

The term “alkyl,” by itself or as part of another substituent, means, unless otherwise stated, a straight, branched, or cyclic chain hydrocarbon (“cycloalkyl”) having the number of carbon atoms designated (i.e., “C₁-C₃₀” means one to thirty carbons). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl. Most preferred are —(C₁-C₁₈)alkyl. In certain examples of the present disclosure, a —(C₁-C₃₀)alkyl group, whether straight, branched, or cyclic, may not be a —C₁alkyl group, and/or may not be a —C₂alkyl group, and/or may not be a —C₃alkyl group, and/or may not be a —C₄alkyl group, and/or may not be a —C₅alkyl group, and/or may not be a —C₆alkyl group, and/or may not be a —C₇alkyl group, and/or may not be —C₈alkyl group, and/or may not be a —C₉alkyl group, and/or may not be a —C₁₀alkyl group, and/or may not be a —C₁₁alkyl group, and/or may not be a —C₁₂alkyl group, and/or may not be a —C₁₃alkyl group, and/or may not be a —C₁₄alkyl group, and/or may not be a —C₁₅alkyl group, and/or may not be a —C₁₆alkyl group, and/or may not be a —C₁₇alkyl group, and/or may not be a —C₁₈alkyl group, and/or may not be a —C₁₉alkyl group, and/or may not be a —C₂₀alkyl group, and/or may not be a —C₂₁alkyl group, and/or may not be a —C₂₂alkyl group, and/or may not be a —C₂₃alkyl group, and/or may not be a —C₂₄alkyl group, and/or may not be a —C₂₅alkyl group, and/or may not be a —C₂₆alkyl group, and/or may not be a —C₂₇alkyl group, and/or may not be a —C₂₈alkyl group, and/or may not be a —C₂₉alkyl group, and/or may not be a —C₃₀alkyl group.

The term “alkylene,” by itself or as part of another substituent, means, unless otherwise stated, a straight, branched, or cyclic chain bivalent saturated aliphatic radical having the number of carbon atoms designated (i.e., “C₁-C₃₀” means one to thirty carbons) such as methylene (“C₁alkylene,” or “—CH₂—”) or that may be derived from an alkene by opening of a double bond or from an alkane by removal of two hydrogen atoms from different carbon atoms. Examples include methylene, methylmethylene, ethylene, propylene, ethylmethylene, dimethylmethylene, methylethylene, butylene, cyclopropylmethylene, dimethylethylene, and propylmethylene. In certain examples of the present disclosure, a —(C₁-C₃₀)alkylene group, whether straight, branched, or cyclic, may not be a —C₁alkylene group, and/or may not be a —C₂alkylene group, and/or may not be a —C₃alkylene group, and/or may not be a —C₄alkylene group, and/or may not be a —C₅alkylene group, and/or may not be a —C₆alkylene group, and/or may not be a —C₇alkylene group, and/or may not be —C₈alkylene group, and/or may not be a —C₉alkylene group, and/or may not be a —C₁₀alkylene group, and/or may not be a —C₁₁alkylene group, and/or may not be a —C₁₂alkylene group, and/or may not be a —C₁₃alkylene group, and/or may not be a —C₁₄alkylene group, and/or may not be a —C₁₅alkylene group, and/or may not be a —C₁₆alkylene group, and/or may not be a —C₁₇alkylene group, and/or may not be a —C₁₈alkylene group, and/or may not be a —C₁₉alkylene group, and/or may not be a —C₂₀alkylene group, and/or may not be a —C₂₁alkylene group, and/or may not be a —C₂₂alkylene group, and/or may not be a —C₂₃alkylene group, and/or may not be a —C₂₄alkylene group, and/or may not be a —C₂₅alkylene group, and/or may not be a —C₂₆alkylene group, and/or may not be a —C₂₇alkylene group, and/or may not be a —C₂₈alkylene group, and/or may not be a —C₂₉alkylene group, and/or may not be a —C₃₀alkylene group.

The term “alkenyl,” by itself or as part of another substituent, means, unless otherwise stated, a stable mono-unsaturated or di-unsaturated straight chain, the unsaturation meaning a carbon-carbon double bond (—CH═CH—), branched chain or cyclic hydrocarbon group having the stated number of carbon atoms (i.e., “C₂-C₃₀” means two to thirty carbons). Examples include vinyl, propenyl, allyl, crotyl, isopentenyl, butadienyl, 1,3-pentadienyl, 1,4-pentadienyl, cyclopentenyl, cyclopentadienyl, and the higher homologs and isomers. Functional groups representing an alkene are exemplified by —CH═CH—CH₂— and CH₂=CH—CH₂—. In certain examples of the present disclosure, a —(C₂-C₃₀)alkenyl group, whether straight, branched, or cyclic, may not be a —C₂alkenyl group, and/or may not be a —C₃alkenyl group, and/or may not be a —C₄alkenyl group, and/or may not be a —C₅alkenyl group, and/or may not be a —C₆alkenyl group, and/or may not be a —C₇alkenyl group, and/or may not be —C₈alkenyl group, and/or may not be a —C₉alkenyl group, and/or may not be a —C₁₀alkenyl group, and/or may not be a —C₁₁alkenyl group, and/or may not be a —C₁₂alkenyl group, and/or may not be a —C₁₃alkenyl group, and/or may not be a —C₁₄alkenyl group, and/or may not be a —C₁₅alkenyl group, and/or may not be a —C₁₆alkenyl group, and/or may not be a —C₁₇alkenyl group, and/or may not be a —C₁₈alkenyl group, and/or may not be a —C₁₉alkenyl group, and/or may not be a —C₂₀alkenyl group, and/or may not be a —C₂₁alkenyl group, and/or may not be a —C₂₂alkenyl group, and/or may not be a —C₂₃alkenyl group, and/or may not be a —C₂₄alkenyl group, and/or may not be a —C₂₅alkenyl group, and/or may not be a —C₂₆alkenyl group, and/or may not be a —C₂₇alkenyl group, and/or may not be a —C₂₈alkenyl group, and/or may not be a —C₂₉alkenyl group, and/or may not be a —C₃₀alkenyl group.

The term “alkenylene,” by itself or as part of another substituent, means, unless otherwise stated, a straight, branched, or cyclic chain bivalent unsaturated aliphatic radical containing a double bond having the number of carbon atoms designated (i.e., “C₂-C₃₀” means two to thirty carbons) and that may be derived from an alkyne by opening of a triple bond or from an alkene by removal of two hydrogen atoms from different carbon atoms. In certain examples of the present disclosure, a —(C₂-C₃₀)alkenylene group, whether straight, branched, or cyclic, may not be a —C₂alkenylene group, and/or may not be a —C₃alkenylene group, and/or may not be a —C₄alkenylene group, and/or may not be a —C₅alkenylene group, and/or may not be a —C₆alkenylene group, and/or may not be a —C₇alkenylene group, and/or may not be —C₈alkenylene group, and/or may not be a —C₉alkenylene group, and/or may not be a —C₁₀alkenylene group, and/or may not be a —C₁₁alkenylene group, and/or may not be a —C₁₂alkenylene group, and/or may not be a —C₁₃alkenylene group, and/or may not be a —C₁₄alkenylene group, and/or may not be a —C₁₅alkenylene group, and/or may not be a —C₁₆alkenylene group, and/or may not be a —C₁₇alkenylene group, and/or may not be a —C₁₈alkenylene group, and/or may not be a —C₁₉alkenylene group, and/or may not be a —C₂₀alkenylene group, and/or may not be a —C₂₁alkenylene group, and/or may not be a —C₂₂alkenylene group, and/or may not be a —C₂₃alkenylene group, and/or may not be a —C₂₄alkenylene group, and/or may not be a —C₂₅alkenylene group, and/or may not be a —C₂₆alkenylene group, and/or may not be a —C₂₇alkenylene group, and/or may not be a —C₂₈alkenylene group, and/or may not be a —C₂₉alkenylene group, and/or may not be a —C₃₀alkenylene group.

The term “alkynyl,” by itself or as part of another substituent, means, unless otherwise stated, a stable carbon-carbon triple bond-containing radical (—C≡C—), branched chain, or cyclic hydrocarbon group having the stated number of carbon atoms (i.e., “C₂-C₃₀” means two to thirty carbons). Examples include ethynyl and propargyl. In certain examples of the present disclosure, a —(C₂-C₃₀)alkynyl group, whether straight, branched, or cyclic, may not be a —C₂alkynyl group, and/or may not be a —C₃alkynyl group, and/or may not be a —C₄alkynyl group, and/or may not be a —C₅alkynyl group, and/or may not be a —C₆alkynyl group, and/or may not be a —C₇alkynyl group, and/or may not be —C₈alkynyl group, and/or may not be a —C₉alkynyl group, and/or may not be a —C₁₀alkynyl group, and/or may not be a —C₁₁alkynyl group, and/or may not be a —C₁₂alkynyl group, and/or may not be a —C₁₃alkynyl group, and/or may not be a —C₁₄alkynyl group, and/or may not be a —C₁₅alkynyl group, and/or may not be a —C₁₆alkynyl group, and/or may not be a —C₁₇alkynyl group, and/or may not be a —C₁₈alkynyl group, and/or may not be a —C₁₉alkynyl group, and/or may not be a —C₂₀alkynyl group, and/or may not be a —C₂₁alkynyl group, and/or may not be a —C₂₂alkynyl group, and/or may not be a —C₂₃alkynyl group, and/or may not be a —C₂₄alkynyl group, and/or may not be a —C₂₅alkynyl group, and/or may not be a —C₂₆alkynyl group, and/or may not be a —C₂₇alkynyl group, and/or may not be a —C₂₈alkynyl group, and/or may not be a —C₂₉alkynyl group, and/or may not be a —C₃₀alkynyl group.

The term “alkynylene,” by itself or as part of another substituent, means, unless otherwise stated, a straight, branched, or cyclic chain bivalent unsaturated aliphatic radical containing a triple bond having the number of carbon atoms designated (i.e., “C₂-C₃₀” means two to thirty carbon atoms) and that may be derived from an alkyne by removal of two hydrogen atoms from different carbon atoms. In certain examples of the present disclosure, a —(C₂-C₃₀)alkynylene group, whether straight, branched, or cyclic, may not be a —C₂alkynylene group, and/or may not be a —C₃alkynylene group, and/or may not be a —C₄alkynylene group, and/or may not be a —C₅alkynylene group, and/or may not be a —C₆alkynylene group, and/or may not be a —C₇alkynylene group, and/or may not be —C₈alkynylene group, and/or may not be a —C₉alkynylene group, and/or may not be a —C₁₀alkynylene group, and/or may not be a —C₁₁alkynylene group, and/or may not be a —C₁₂alkynylene group, and/or may not be a —C₁₃alkynylene group, and/or may not be a —C₁₄alkynylene group, and/or may not be a —C₁₅alkynylene group, and/or may not be a —C₁₆alkynylene group, and/or may not be a —C₁₇alkynylene group, and/or may not be a —C₁₈alkynylene group, and/or may not be a —C₁₉alkynylene group, and/or may not be a —C₂₀alkynylene group, and/or may not be a —C₂₁alkynylene group, and/or may not be a —C₂₂alkynylene group, and/or may not be a —C₂₃alkynylene group, and/or may not be a —C₂₄alkynylene group, and/or may not be a —C₂₅alkynylene group, and/or may not be a —C₂₆alkynylene group, and/or may not be a —C₂₇alkynylene group, and/or may not be a —C₂₈alkynylene group, and/or may not be a —C₂₉alkynylene group, and/or may not be a —C₃₀alkynylene group.

The term “alkoxy,” by itself or as part of another substituent, means, unless otherwise stated, an alkyl group having the designated number of carbon atoms, as defined above, connected to the rest of the molecule via an oxygen atom, such as, for example, methoxy, ethoxy, 1-propoxy, 2-propoxy (“isopropoxy”), and the higher homologs and isomers. In certain examples of the present disclosure, a —(C₁-C₃₀)alkoxy group, whether straight, branched, or cyclic, may not be a —C₁alkoxy group, and/or may not be a —C₂alkoxy group, and/or may not be a —C₃alkoxy group, and/or may not be a —C₄alkoxy group, and/or may not be a —C₅alkoxy group, and/or may not be a —C₆alkoxy group, and/or may not be a —C₇alkoxy group, and/or may not be —C₈alkoxy group, and/or may not be a —C₉alkoxy group, and/or may not be a —C₁₀alkoxy group, and/or may not be a —C₁₁alkoxy group, and/or may not be a —C₁₂alkoxy group, and/or may not be a —C₁₃alkoxy group, and/or may not be a —C₁₄alkoxy group, and/or may not be a —C₁₅alkoxy group, and/or may not be a —C₁₆alkoxy group, and/or may not be a —C₁₇alkoxy group, and/or may not be a —C₁₈alkoxy group, and/or may not be a —C₁₉alkoxy group, and/or may not be a —C₂₀alkoxy group, and/or may not be a —C₂₁alkoxy group, and/or may not be a —C₂₂alkoxy group, and/or may not be a —C₂₃alkoxy group, and/or may not be a —C₂₄alkoxy group, and/or may not be a —C₂₅alkoxy group, and/or may not be a —C₂₆alkoxy group, and/or may not be a —C₂₇alkoxy group, and/or may not be a —C₂₈alkoxy group, and/or may not be a —C₂₉alkoxy group, and/or may not be a —C₃₀alkoxy group.

The term “alkenyloxy,” by itself or as part of another substituent, means, unless otherwise stated, an alkenyl group having the designated number of carbon atoms, as defined above, connected to the rest of the molecule via an oxygen atom.

The term “alkynyloxy,” by itself or as part of another substituent, means, unless otherwise stated, an alkynyl group having the designated number of carbon atoms, as defined above, connected to the rest of the molecule via an oxygen atom.

The term “aromatic” generally refers to a carbocycle or heterocycle having one or more polyunsaturated rings having aromatic character (i.e., having (4n+2) delocalized π (pi) electrons where n is an integer).

The term “aryl,” by itself or in combination with another substituent, means, unless otherwise stated, a carbocyclic aromatic system containing one or more rings (typically one, two, or three rings) wherein such rings may be attached together in a pendant manner, such as a biphenyl, or may be fused, such as naphthalene. Examples may include phenyl, anthracyl, and naphthyl. Preferred are phenyl, benzyl, and naphthyl, most preferred are phenyl and benzyl.

The term “aryloxy,” by itself or in combination with another substituent, means, unless otherwise stated, an aryl group connected to the rest of the molecule via an oxygen atom.

The term “arylene,” by itself or in combination with another substituent, means, unless otherwise stated, a bivalent radical produced by removal of two hydrogen atoms from two different carbon atoms of an aryl group.

The terms “heterocycle” or “heterocyclyl” or “heterocyclic,” by themselves or as part of other substituents, mean, unless otherwise stated, an unsubstituted or substituted, stable, mono- or multi-cyclic heterocyclic ring system that consists of carbon atoms and at least one heteroatom independently selected from the group consisting of N, O, and S, and wherein the nitrogen and sulfur heteroatoms may be optionally oxidized, and the nitrogen atom may be optionally quaternized. The heterocyclic system may be attached, unless otherwise stated, at any heteroatom or carbon atom that affords a stable structure.

The term “heterocyclyloxy,” by itself or in combination with another substituent, means, unless otherwise stated, an aryl group connected to the rest of the molecule via an oxygen atom.

The term “heterocyclylene,” by itself or in combination with another substituent, means, unless otherwise stated, a bivalent radical produced by removal of two hydrogen atoms from two different carbon atoms of a heterocyclyl group.

The terms “heteroaryl” or “heteroaromatic,” by themselves or as part of other substituents, mean, unless otherwise stated, a heterocyclic having aromatic character. A polycyclic heteroaryl may include fused rings. Examples include indole, 1H-indazole, 1H-pyrrolo[2,3-b]pyridine, and the like. A polycyclic heteroaryl may include one or more rings that are partially saturated. Examples include indoline, tetrahydroquinoline, and 2,3-dihydrobenzofuryl.

Non-limiting examples of heteroaryl groups include: pyridyl; pyrazinyl; pyrimidinyl, particularly 2- and 4-pyrimidinyl; pyridazinyl; thienyl; furyl; pyrrolyl, particularly 2-pyrrolyl; imidazolyl; thiazolyl; oxazolyl; pyrazolyl, particularly 3- and 5-pyrazolyl; isothiazolyl; 1,2,3-triazolyl; 1,2,4-triazolyl; 1,3,4-triazolyl; tetrazolyl; 1,2,3-thiadiazolyl; 1,2,3-oxadiazolyl; 1,3,4-thiadiazolyl; and 1,3,4-oxadiazolyl.

Polycyclic heterocycles include both aromatic and non-aromatic polycyclic heterocycles. Non-limiting examples of polycyclic heterocycles include: indolyl, particularly 3-, 4-, 5-, 6-, and 7-indolyl; indolinyl; indazolyl, particularly 1H-indazol-5-yl; quinolyl; tetrahydroquinolyl; isoquinolyl, particularly 1- and 5-isoquinolyl; 1,2,3,4-tetrahydroisoquinolyl; cinnolyl; quinoxalinyl, particularly 2- and 5-quinoxalinyl; quinazolinyl; phthalazinyl; naphthyridinyl, particularly 1,5- and 1,8-naphthyridinyl; 1,4-benzodioxanyl; coumaryl; dihydrocoumaryl; benzofuryl, particularly 3-, 4-, 5-, 6-, and 7-benzofuryl; 2,3-dihydrobenzofuryl; 1,2-benzisoxazoyl; benzothienyl, particularly 3-, 4-, 5-, 6-, and 7-benzothienyl; benzoxazolyl; benzothiazolyl, particularly 2- and 5-benzothiazolyl; purinyl; benzimidazolyl, particularly 2-benzimidazolyl; benztriazolyl; thioxanthinyl; carbazolyl; carbolinyl; acridinyl; pyrrolizidinyl; pyrrolo[2,3-b]pyridinyl, particularly 1H-pyrrolo[2,3-b]pyridine-5-yl; and quinolizidinyl. Particularly preferred are 4-indolyl, 5-indolyl, 6-indolyl, 1H-indazol-5-yl, and 1H-pyrrolo[2,3-b]pyridin-5-yl.

The term “heteroaryloxy,” by itself or in combination with another substituent, means, unless otherwise stated, a heteroaryl group connected to the rest of the molecule via an oxygen atom.

The term “heteroarylene,” by itself or in combination with another substituent, means, unless otherwise stated, a bivalent radical produced by removal of two hydrogen atoms from two different carbon atoms of a heteroaryl group.

The term “aryl(C₁-C₄)alkyl” means a functional group wherein a one to four carbon alkylene chain is attached to an aryl group, e.g., —CH₂—CH₂-phenyl. Examples may include benzyl. The term “heteroaryl(C₁-C₄)alkyl” means a functional group wherein a one to four carbon alkylene chain is attached to a heteroaryl group, e.g., —CH₂—CH₂-pyridyl. The term “heterocyclyl(C₁-C₄)alkyl” means a functional group wherein a one to four carbon alkylene chain is attached to a heterocyclyl group, e.g., —CH₂—CH₂-aziridine. The terms “aryl(C₁-C₄)alkylene” or “(C₁-C₄)alkylarylene” mean a bivalent radical produced by removal of two hydrogen atoms from two different carbon atoms of an aryl(C₁-C₄)alkyl group, preferably wherein one of the two different carbon atoms is in the (C₁-C₄)alkyl group and the other of the two different carbon atoms is in the aryl group. The term “(C₁-C₄)alkylaryl(C₁-C₄)alkylene” means a bivalent radical produced by removal of two hydrogen atoms from two different carbon atoms of a (C₁-C₄)alkylaryl(C₁-C₄)alkyl group, wherein one of the two different carbon atoms is in one of the (C₁-C₄)alkyl groups and the other of the two different carbon atoms is in the other of the (C₁-C₄)alkyl groups, e.g., —CH₂-phenyl-CH₂—. The terms “heteroaryl(C₁-C₄)alkylene” or “(C₁-C₄)alkylheteroarylene” mean a bivalent radical produced by removal of two hydrogen atoms from two different carbon atoms of a heteroaryl(C₁-C₄)alkyl group, preferably wherein one of the two different carbon atoms is in the (C₁-C₄)alkyl group and the other of the two different carbon atoms is in the heteroaryl group. The term “(C₁-C₄)alkylheteroaryl(C₁-C₄)alkylene” means a bivalent radical produced by removal of two hydrogen atoms from two different carbon atoms of a (C₁-C₄)alkylheteroaryl(C₁-C₄)alkyl group, wherein one of the two different carbon atoms is in one of the (C₁-C₄)alkyl groups and the other of the two different carbon atoms is in the other of the (C₁-C₄)alkyl groups, e.g., —CH₂-pyridinyl-CH₂—. The terms “heterocyclyl(C₁-C₄)alkylene” or “(C₁-C₄)alkylheterocyclene” mean a bivalent radical produced by removal of two hydrogen atoms from two different carbon atoms of an heterocyclyl(C₁-C₄)alkyl group, preferably wherein one of the two different carbon atoms is in the (C₁-C₄)alkyl group and the other of the two different carbon atoms is in the heterocyclyl group. The term “(C₁-C₄)alkylheterocyclyl(C₁-C₄)alkylene” means a bivalent radical produced by removal of two hydrogen atoms from two different carbon atoms of a (C₁-C₄)alkylheterocyclyl(C₁-C₄)alkyl group, wherein one of the two different carbon atoms is in one of the (C₁-C₄)alkyl groups and the other of the two different carbon atoms is in the other of the (C₁-C₄)alkyl groups, e.g., —CH₂-aziridinyl-CH₂—.

The term “silyl,” by itself or in combination with another term, means, unless otherwise stated, a radical derived from silane (“SiH₄”) in which one of the hydrogen atoms has been removed. The term “substituted silyl,” by itself or in combination with another substituent, means, unless otherwise stated, a radical derived from silyl in which up to three hydrogen atoms have been replaced by organic substituents.

As used herein, the term “durable” refers to the tendency of the atomic bonds of the durable phase to remain intact during and after interaction with a leachate. As used herein, the term “degradable” refers to the tendency of the atomic bonds of the degradable phase to break during and after interaction with one or more leachates.

In an example, the present disclosure provides antimicrobial thermoset coating formulations including a copper-containing material, an additive compound, and a thermo- or UV-curable resin. The antimicrobial thermoset coating formulations of the examples of the present disclosure demonstrate synergistic antimicrobial efficacy over and above antimicrobial formulations that include a copper-containing material in amounts such as 20 weight percent or greater relative to total weight percent of the entire formulation. Further, the antimicrobial thermoset coating formulations of the present disclosure demonstrate synergistic antimicrobial efficacy over and above antimicrobial formulations that include a copper-containing material in an amount of only 5 weight percent but that do not include an additive compound.

In another example, the present disclosure provides antimicrobial thermoset coating formulations including an additive compound and a thermo- or UV-curable resin. The antimicrobial thermoset coating may include include a copper-containing material. For example, the copper-containing material may include copper-containing glass, copper oxide, copper metal, copper salt (e.g., copper halide, copper acetate, or copper sulfate, or a combination thereof. In certain examples, the antimicrobial thermoset coating formulations may further include cuprous oxide or a copper-containing material. The antimicrobial thermoset coating formulations of the examples of the present disclosure demonstrate synergistic antimicrobial efficacy over and above antimicrobial formulations that include a copper-containing material in an amount such as 20 weight percent or greater relative to total weight percent of the entire formulation.

The effectiveness of a formulation of the present disclosure as a biocidal composition may be measured as a function of the composition's logarithmic reduction. The composition's logarithmic reduction value may be relevant to its ability to kill a wide variety of biological organisms to which the composition is exposed, but may also allow the copper-containing material to act as a preservative for the composition during storage (e.g., in a container such as, but not limited to a tank, a can, a bucket, a drum, a bottle, or a tube). According to examples of the present disclosure, a logarithmic reduction of the biocidal composition may be at least about 2, at least about 3, at least about 4, at least about 5, at least about 6, at least about 7, at least about 8, at least about 9, at least about 10, in a range from about 1 to about 10, about 3 to about 7, about 4 to about 6, or less than, equal to, or greater than about 1, 2, 3, 4, 5, 6, 7, 8, 9, or about 10. The biocidal properties of the composition may make it effective for substantially killing a wide variety of biological organisms including bacteria, viruses, and fungi. Where the coating is configured to have biocidal properties with respect to bacteria, suitable examples of bacteria include Staphylococcus aureus, Enterobacter aerogenes, Pseudomonas aeruginosa, Methicillin Resistant Staphylococcus aureus, E. coli, and mixtures thereof. In some examples, the copper-containing material exhibits at least a 4 logarithmic reduction, a 5 logarithmic reduction, or even a 6 logarithmic reduction in the concentration of at least one of Staphylococcus aureus, Enterobacter aerogenes, Pseudomonas aeruginosa bacteria, Methicillin Resistant Staphylococcus aureus, and E. coli under the EPA test, or a 4 logarithmic reduction or greater (e.g., 5 logarithmic reduction or greater) under JIS Z 2801 (2000) testing conditions or under the Modified JIS Z 2801 Test for Bacteria. In one or more examples described herein, the copper-containing particles exhibit a 2 logarithmic reduction or greater, a 3 logarithmic reduction or greater, a 4 logarithmic reduction or greater, or a 5 logarithmic reduction or greater in Murine Novovirus under a Modified JIS Z 2801 for Viruses test. The procedure for the Modified JIS Z 2801 (2000) Test for Viruses is provided in International Patent Application Pub. No. 2021/055300 A1, COLOR STABILIZATION OF BIOCIDAL COATINGS, which is incorporated by reference herein in its entirety.

In some examples, the material may exhibit the logarithmic reductions described herein under one or more of the U.S. Environmental Protection Agency “Test Method of Efficacy of Copper Alloy as a Sanitizer” (2009) (also referred to herein as the “EPA Test”), the Modified Japanese Industrial Standard (JIS) Z 2801 Test for Bacteria and/or the Modified JIS Z2801 Test for Viruses, for a period of one month or greater or for a period of three months or greater. The one-month period or three-month period may commence at or after the application of the material to a surface as a layer. In such examples, the layer exhibits the logarithmic reductions described herein.

The copper-containing glass particles may be a biocidal inorganic glass powder including copper particles. The copper particles may independently include a Cu metal, Cu¹⁺, Cu²⁺, or a combination of Cu¹⁺ of Cu²⁺. The combined total of the Cu species may be about 10 weight % or more of the copper-containing material. However, as will be discussed in more detail below, the amount of Cu²⁺ may be minimized or reduced such that the copper-containing glass particles may be substantially free of Cu²⁺. The copper may be non-complexed or may have a ligand bonded thereto to form a complex. The Cu¹⁺ ions may be present on or in the surface and/or the bulk of the copper-containing glass particles. The copper-containing glass particles may include copper-containing glass, copper (I) oxide, copper (I) halides, copper (I) carbonate, or a combination thereof. In some examples, the copper-containing glass particles may include only one of copper-containing glass, copper (I) oxide, copper (I) halides, or copper (I) carbonate. In some examples, the Cu¹⁺ ions may be present in a glass network and/or a glass matrix of the copper-containing glass particles. Where the Cu¹⁺ ions are present in the glass network, the Cu¹⁺ ions are atomically bonded to the atoms in the glass network. Where the Cu¹⁺ ions are present in the glass matrix, the Cu¹⁺ ions may be present in the form of Cu¹⁺ crystals that are dispersed in the glass matrix. In some examples, the Cu¹⁺ crystals include cuprite (Cu₂O). In some examples, where Cu¹⁺ crystals are present, the material may be referred to as a glass ceramic, which is intended to refer to a specific type of glass with crystals that may or may not be subjected to a traditional ceramming process by which one or more crystalline phases are introduced and/or generated in the glass. Where the Cu¹⁺ ions are present in a non-crystalline form, the material may be referred to as a copper-containing glass. In some examples, both Cu¹⁺ crystals and Cu¹⁺ ions not associated with a crystal are present in the copper-containing glasses described herein.

The copper-containing glasses may include a copper-containing oxide in an amount, in mole percent, in the range from about 10 to about 50, from about 10 to about 49, from about 10 to about 48, from about 10 to about 47, from about 10 to about 46, from about 10 to about 45, from about 10 to about 44, from about 10 to about 43, from about 10 to about 42, from about 10 to about 41, from about 10 to about 40, from about 10 to about 39, from about 10 to about 38, from about 10 to about 37, from about 10 to about 36, from about 10 to about 35, from about 10 to about 34, from about 10 to about 33, from about 10 to about 32, from about 10 to about 31, from about 10 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 11 to about 50, from about 12 to about 50, from about 13 to about 50, from about 14 to about 50, from about 15 to about 50, from about 16 to about 50, from about 17 to about 50, from about 18 to about 50, from about 19 to about 50, from about 20 to about 50, from about 10 to about 30, from about 11 to about 29, from about 12 to about 28, from about 13 to about 27, from about 14 to about 26, from about 15 to about 25, from about 16 to about 24, from about 17 to about 23, from about 18 to about 22, from about 19 to about 21, and all ranges and sub-ranges therebetween. According to examples of the present disclosure, the copper-containing oxide may be present in the copper-containing glasses in an amount of about 20 mole percent, about 25 mole percent, about 30 mole percent, or about 35 mole percent. The copper-containing oxide may include CuO, Cu₂O, and/or combinations thereof. The copper-containing oxides in the copper-containing glasses form the Cu¹⁺ ions present in the resulting glass. Copper may be present in a glass composition and/or the glasses including a glass composition in various forms, including Cu⁰, Cu¹⁺, and Cu²⁺. Copper in the Cu⁰ or Cu¹⁺ forms provide antimicrobial activity. However, forming and maintaining these states of antimicrobial copper are difficult, and often, in known glass compositions, Cu²⁺ may be formed instead of the desired Cu⁰ or Cu¹⁺ ions.

Although the individual particles of the copper-containing glass particles may be effective as a biocidal agent, a potential drawback may be that the copper offers numerous opportunities for ligands to attach thereto. The copper-containing glass particles may include cuprous oxide in an amount from 29.0 to 36.0 weight percent of the copper-containing glass particles.

The copper-containing glass portion of the individual particles of the copper-containing glass particles may be formed from a glass composition that may include, but is not limited to, in mole percent, SiO₂ in the range from about 30 to about 70, Al₂O₃ in the range from about 0 to about 20, a copper-containing oxide in the range from about 10 to about 50, CaO in the range from about 0 to about 15, MgO in the range from about 0 to about 15, P₂O₅ in the range from about 0 to about 25, B₂O₃ in the range from about 0 to about 25, K₂O in the range from about 0 to about 20, ZnO in the range from about 0 to about 5, Na₂O in the range from about 0 to about 20, and/or Fe₂O₃ in the range from about 0 to about 5, nanoparticles thereof, and/or a mixture thereof. In such examples, the amount of the copper-containing oxide is greater than the amount of Al₂O₃. In some examples, the glass composition may include a content of R₂O, where R may include K, Na, Li, Rb, Cs, and combinations thereof.

In one or more examples, the glass composition may include one or more divalent cation oxides, such as alkaline earth oxides and/or ZnO. Such divalent cation oxides may be included to improve the melting behavior of the glass compositions. With respect to ion exchange performance, the presence of divalent cations may act to decrease alkali mobility and thus, when larger divalent cation oxides are utilized, there may be a negative effect on ion exchange performance. Further, smaller divalent cation oxides generally help the compressive stress developed in an ion-exchanged glass more than the larger divalent cation oxides. Hence, divalent cation oxides such as MgO and ZnO may offer advantages with respect to improved stress relaxation, while minimizing the adverse effects on alkali diffusivity.

In one or more examples, the glass composition may include one or more colorants. Examples of such colorants may include TiO₂, Fe₂O₃, Cr₂O₃, Co₃O₄, and other known colorants. In some examples, the one or more colorants may be present in an amount in the range up to about 10 mol %. In some examples, the one or more colorants may be present in an amount in the range from about 0.01 mol % to about 10 mol %, from about 1 mol % to about 10 mol %, from about 2 to about 10 mol %, from about 5 mol % to about 10 mol %, from about 0.01 mol % to about 8 mol %, or from about 0.01 mol % to about 5 mol %.

The copper-containing glasses formed from the glass compositions may include a plurality of Cu¹⁺ ions. In some examples, such Cu¹⁺ ions form part of the glass network and may be characterized as a glass modifier. Without being bound by theory, where Cu¹⁺ ions are part of the glass network, it is believed that during typical glass formation processes, the cooling step of the molten glass occurs too rapidly to allow crystallization of the copper-containing oxide (e.g., Cu and/or Cu₂O). Thus, the Cu¹⁺ remains in an amorphous state and becomes part of the glass network. In some cases, the total amount of Cu¹⁺ ions, whether the Cu¹⁺ ions are in a crystalline phase or in the glass matrix, may be even higher, such as up to 40 mol %, up to 50 mol %, or up to 60 mol %.

In one or more examples, the copper-containing glasses formed from the glass compositions disclosed herein include Cu¹⁺ ions that are dispersed in the glass matrix as Cu¹⁺ crystals. In one or more examples, the Cu¹⁺ may be present in the form of cuprite. The cuprite present in the copper-containing glass may form a phase that is distinct from the glass matrix or glass phase. In other examples, the cuprite may form part of or may be associated with one or more glass phases (e.g., the durable phase described herein).

In some examples, the total amount of extractable copper by weight % in the copper-containing glass particles may be in the range from about 10 to about 70, from about 15 to about 70, from about 20 to about 70, from about 25 to about 70, from about 10 to about 65, from about 10 to about 60, from about 10 to about 55, from about 10 to about 50, from about 10 to about 45, from about 10 to about 40, from about 10 to about 35, from about 20 to about 50, from about 20 to about 45, from about 20 to about 40, from about 20 to about 35, from about 25 to about 35, from about 21 to about 40, from about 22 to about 40, from about 23 to about 40, from about 24 to about 40, from about 25 to about 40, from about 20 to about 39, from about 20 to about 38, from about 20 to about 37, from about 20 to about 36, from about 20 to about 35, from about 26 to about 34, from about 27 to about 33, from about 28 to about 32, from about 29 to about 31, and all ranges and sub-ranges therebetween; less than, equal to, or greater than about 5 weight %, 10, 15, 20, 25, 30, 35, 40, 45, 50, 55, 60, 65, 70, 75, or about 80 weight %. In one or more examples, the ratio of Cu¹⁺ ions to the total amount of extractable copper in the copper-containing glass particles is about 0.5 or greater, 0.55 or greater, 0.6 or greater, 0.65 or greater, 0.7 or greater, 0.75 or greater, 0.8 or greater, 0.85 or greater, 0.9 or greater, or even 1 or greater, and all ranges and sub-ranges therebetween.

According to some examples of the present disclosure, the copper-containing material and/or materials described herein leach the copper ions when exposed or in contact with a leachate. In one or more examples, the copper-containing material leach only copper ions when exposed to leachates including water. The copper-containing material may include at least a first phase and a second phase. In one or more examples, the copper-containing material may include two or more phases wherein the phases differ based on the ability of the atomic bonds in the given phase to withstand interaction with a leachate. Specifically, the copper-containing material of one or more examples may include a first phase that may be described as a degradable phase and a second phase that may be described as a durable phase. As used herein, the term “durable” refers to the tendency of the atomic bonds of the durable phase to remain intact during and after interaction with a leachate. As used herein, the term “degradable” refers to the tendency of the atomic bonds of the degradable phase to break during and after interaction with one or more leachates. In one or more examples, the durable phase includes SiO₂ and the degradable phase includes at least one of B₂O₃, P₂O₅, and R₂O (where R may include any one or more of K, Na, Li, Rb, and Cs). Without wishing to be bound by theory, it is believed that the components of the degradable phase (e.g., B₂O₃, P₂O₅, and/or R₂O) more readily interact with a leachate and the bonds between these components to one another rand to other components in the copper-containing glass more readily break during and after the interaction with the leachate. Leachates may include water, acids or other similar materials. In one or more examples, the degradable phase withstands degradation for 1 week or longer, 1 month or longer, 3 months or longer, or even 6 months or longer. In some examples, longevity may be characterized as maintaining antimicrobial efficacy over a specific period of time. In one or more examples, either one or both of the durable phase and degradable phase may include cuprite. The cuprite in such examples may be dispersed in the respective phase or in both phases.

Although the individual particles of the copper-containing material may be effective as a biocidal agent, a potential drawback may be that the copper offers numerous opportunities for ligands to attach thereto, resulting in complexes that may alter the color of a coating formulation to which it is ultimately incorporated. The copper-containing material may include cuprous oxide in an amount from 29.0 to 36.0 weight percent of the copper-containing material.

The copper of the individual particles of the copper-containing material may be present in any suitable amount, including, but not limited to: in a range of from about 5 weight % to about 80 weight % of the individual particles of the copper-containing material, about 10 weight % to about 70 weight %, about 25 weight % to about 35 weight %, about 40 weight % to about 60 weight %, about 45 weight % to about 55 weight %; less than, equal to, or greater than about 5 weight %, 10, 15, 20, 25, 30, 35, 40, 45, 50, 55, 60, 65, 70, 75, or about 80 weight %. In a copper-containing glass particle, the copper portion can comprise one or more of Cu metal, Cu¹⁺, Cu²⁺, or a combination of Cu¹⁺ and Cu²⁺. The copper may be non-complexed or may have a ligand bonded thereto to form a complex.

Examples of copper-containing glasses include, without limitation, those described in U.S. Pat. No. 9,622,483, ANTIMICROBIAL GLASS COMPOSITIONS, GLASSES AND POLYMERIC ARTICLES INCORPORATING THE SAME, and International Patent Application Pub. No. 2017/132179, ANTIMICROBIAL PHASE-SEPARABLE GLASS/POLYMER ARTICLES AND METHODS FOR MAKING THE SAME, each of which is incorporated by reference herein in its entirety.

In accordance with an example, the present disclosure provides additive compounds, and the use thereof to improve antimicrobial efficacy of antimicrobial thermoset coating formulations.

In an example, an additive compound may be a compound of formula (I):

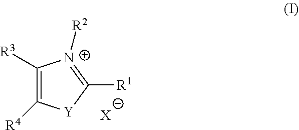

wherein X⁻ is selected from the group consisting of fluoride, chloride, bromide, iodide, hexafluorophosphate, sulfate, trifluoromethanesulfonate, an alkylsulfonate, and an arylsulfonate;

Y is selected from the group consisting of S, S(O), SO₂, NR¹, and PR¹; and

each R¹, R², R³, and R⁴ is independently selected from the group consisting of hydrogen, (C₁-C₃₀)alkyl, (C₂₋₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl; and

wherein the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy.

Certain examples of compounds of formula (I) may include particular combinations of X⁻, Y, R¹, R², R³, and R⁴ that ultimately provide the surprising and unexpected effect of improved antimicrobial efficacy in antimicrobial thermoset coating formulations of the present disclosure, but not as efficiently as other particular combinations of X⁻, Y, R¹, R², R³, and R⁴ due to the combined effects of chemical phenomena understood by those skilled in the art, including, but not limited to, dipole moment, polarity, solubility, electronic effects, and/or steric effects resulting from the chemical structure of a particular compound of formula (I). In certain examples of compounds of formula (I), X⁻ may not be fluoride, and/or may not be chloride, and/or may not be bromide, and/or may not be iodide, and/or may not be hexafluorophosphate, and/or may not be sulfate, and/or may not be trifluoromethanesulfonate, and/or may not be an alkylsulfonate, and/or may not be an arylsulfonate. In certain examples of compounds of formula (I), Y may not be S, and/or may not be S(O), and/or may not be SO₂, and/or may not be NR¹, and/or may not be PR¹. In certain examples of compounds of formula (I), each of R¹, R², R³, and R⁴, independently, may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl, and/or may not be a substituted silyl. In certain examples of compounds of formula (I), each substituent of a substituted silyl may not be hydrogen, and/or may not be (C₁-C₃₀)alkyl, and/or may not be (C₁₋₃₀₀₀₀₀₀₀)alkoxy, and/or may not be (C₂-C₃₀)alkenyl, and/or may not be (C₂-C₃₀)alkenyloxy, and/or may not be (C₂₋₃₀)alkynyl, and/or may not be (C₂—C₃₀)alkynyloxy, and/or may not be aryl, and/or may not be aryloxy, and/or may not be heteroaryl, and/or may not be heteroaryloxy, and/or may not be heterocyclyl, and/or may not be heterocyclyloxy, and/or may not be aryl(C₁-C₄)alkyl, and/or may not be aryl(C₁-C₄)alkoxy, and/or may not be heteroaryl(C₁-C₄)alkyl, and/or may not be heteroaryl(C₁-C₄)alkoxy, and/or may not be heterocyclyl(C₁-C₄)alkyl, and/or may not be heterocyclyl(C₁-C₄)alkoxy.

Examples of compounds of formula (I) may include 1-butyl-3-methylimidazolium (“BMIM”) bromide, which has the structural formula:

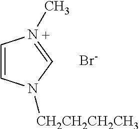

In another example, an additive compound may be a compound of formula (II):

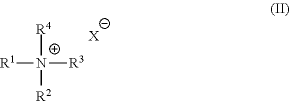

wherein each of X⁻, R¹, R², R³, and R⁴ is as defined above for compounds of formula (I).

Certain examples of compounds of formula (II) may include particular combinations of X⁻, R¹, R², R³, and R⁴ that ultimately provide the surprising and unexpected effect of improved antimicrobial efficacy in antimicrobial thermoset coating formulations of the present disclosure, but not as efficiently as other particular combinations of X⁻, R¹, R², R³, and R⁴ due to the combined effects of chemical phenomena understood by those skilled in the art, including, but not limited to, dipole moment, polarity, solubility, electronic effects, and/or steric effects resulting from the chemical structure of a particular compound of formula (II). In certain examples of compounds of formula (II), X⁻ may not be fluoride, and/or may not be chloride, and/or may not be bromide, and/or may not be iodide, and/or may not be hexafluorophosphate, and/or may not be sulfate, and/or may not be trifluoromethanesulfonate, and/or may not be an alkylsulfonate, and/or may not be an arylsulfonate. In certain examples of compounds of formula (II), each of Ri, R², R³, and R⁴, independently, may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl, and/or may not be a substituted silyl. In certain examples of compounds of formula (II), each substituent of a substituted silyl may not be hydrogen, and/or may not be (C₁-C₃₀)alkyl, and/or may not be (C₁-C₃₀)alkoxy, and/or may not be (C₂-C₃₀)alkenyl, and/or may not be (C₂-C₃₀)alkenyloxy, and/or may not be (C₂-C₃₀)alkynyl, and/or may not be (C₂-C₃₀)alkynyloxy, and/or may not be aryl, and/or may not be aryloxy, and/or may not be heteroaryl, and/or may not be heteroaryloxy, and/or may not be heterocyclyl, and/or may not be heterocyclyloxy, and/or may not be aryl(C₁-C₄)alkyl, and/or may not be aryl(C₁-C₄)alkoxy, and/or may not be heteroaryl(C₁-C₄)alkyl, and/or may not be heteroaryl(C₁-C₄)alkoxy, and/or may not be heterocyclyl(C₁-C₄)alkyl, and/or may not be heterocyclyl(C₁-C₄)alkoxy.

Examples of compounds of formula (II) may include benzalkonium chlorides and didecyldimethylammonium chloride. Benzalkonium chlorides (“BKCs”) may have the structural formula:

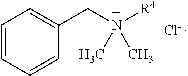

Didecyldimethylammonium chloride (“DDAC”) has the structural formula:

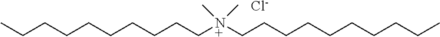 [SMILES: CCCCCCCCCC[N+](C)(C)CCCCCCCCCC ; [Cl-]]

In yet another example, an additive compound may be a compound of formula (III):

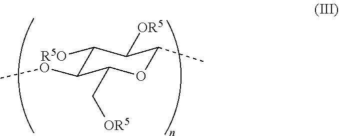

wherein R⁵ is selected from the group consisting of hydrogen, (C₁-C₃₀)alkyl, aryl, —CH₂CH₂OH, and —CH₂Co₂H; and

wherein the molecular weight of the compound of formula (III) is from 5000 g/mole to 1·10⁶ g/mole.

Certain examples of compounds of formula (III) may include particular R substituents that ultimately provide the surprising and unexpected effect of improved antimicrobial efficacy in antimicrobial thermoset coating formulations of the present disclosure, but not as efficiently as other particular R substituents due to the combined effects of chemical phenomena understood by those skilled in the art, including, but not limited to, dipole moment, polarity, solubility, electronic effects, and/or steric effects resulting from the chemical structure of a particular compound of formula (III). In certain examples of compounds of formula (III), R⁵ may not be hydrogen, and/or may not be —CH₂CH₂OH, and/or may not be —CH₂Co₂H.

Examples of compounds of formula (III) may include hydroxyethyl cellulose (“HEC”) and carboxymethyl cellulose (“CMC”).

In yet another example, an additive compound may be a compound of formula (IV):

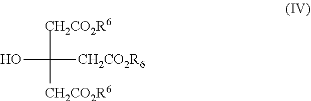

wherein each R⁶ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl; and

wherein the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy.

Certain examples of compounds of formula (IV) may include particular R⁶ substituents that ultimately provide the surprising and unexpected effect of improved antimicrobial efficacy in antimicrobial thermoset coating formulations of the present disclosure, but not as efficiently as other particular R⁶ substituents due to the combined effects of chemical phenomena understood by those skilled in the art, including, but not limited to, dipole moment, polarity, solubility, electronic effects, and/or steric effects resulting from the chemical structure of a particular compound of formula (IV). In certain examples of compounds of formula (IV), each R⁶ substituent may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl, and/or may not be a substituted silyl. In certain examples of compounds of formula (IV), each substituent of a substituted silyl may not be hydrogen, and/or may not be (C₁-C₃₀)alkyl, and/or may not be (C₁-C₃₀)alkoxy, and/or may not be (C₂-C₃₀)alkenyl, and/or may not be (C₂-C₃₀)alkenyloxy, and/or may not be (C₂-C₃₀)alkynyl, and/or may not be (C₂-C₃₀)alkynyloxy, and/or may not be aryl, and/or may not be aryloxy, and/or may not be heteroaryl, and/or may not be heteroaryloxy, and/or may not be heterocyclyl, and/or may not be heterocyclyloxy, and/or may not be aryl(C₁-C₄)alkyl, and/or may not aryl(C₁-C₄)alkoxy, and/or may not be heteroaryl(C₁-C₄)alkyl, and/or may not be heteroaryl(C₁-C₄)alkoxy, and/or may not be heterocyclyl(C₁-C₄)alkyl, and/or may not be heterocyclyl(C₁-C₄)alkoxy.

Examples of compounds of formula (IV) may include triethyl citrate, which has the structural formula:

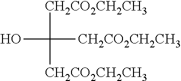

In yet another example, an additive compound may be a polyethylene glycol compound of formula (V):

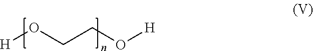

wherein the molecular weight of the compound of formula (V) is from 1000 g/mole to 50000 g/mole.

In yet another example, an additive compound may be a compound of formula (VI):

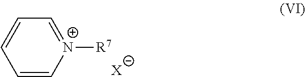

wherein X⁻ is as defined above for compounds of formula (I); and

R⁷ is selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl; and

wherein the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy.

Certain examples of compounds of formula (IV) may include particular combinations of X⁻ and R⁷ that ultimately provide the surprising and unexpected effect of improved antimicrobial efficacy in antimicrobial thermoset coating formulations of the present disclosure, but not as efficiently as other particular combinations of X⁻ and R⁷ due to the combined effects of chemical phenomena understood by those skilled in the art, including, but not limited to, dipole moment, polarity, solubility, electronic effects, and/or steric effects resulting from the chemical structure of a particular compound of formula (VI). In certain examples of compounds of formula (VI), X⁻ may not be fluoride, and/or may not be chloride, and/or may not be bromide, and/or may not be iodide, and/or may not be hexafluorophosphate, and/or may not be sulfate, and/or may not be trifluoromethanesulfonate, and/or may not be an alkylsulfonate, and/or may not be an arylsulfonate. In certain examples of compounds of formula (VI), R⁷ may not be hydrogen, and/or may not be (C₁-C₃₀)alkyl, and/or may not be (C₂-C₃₀)alkenyl, and/or may not be (C₂-C₃₀)alkynyl, and/or may not be aryl(C₁-C₄)alkyl, and/or may not be heteroaryl(C₁-C₄)alkyl, and/or may not be heterocyclyl(C₁-C₄)alkyl, and/or may not be a substituted silyl. In certain examples of compounds of formula (VI), each substituent of a substituted silyl may not be hydrogen, and/or may not be (C₁-C₃₀)alkyl, and/or may not be (C₁-C₃₀)alkoxy, and/or may not be (C₂-C₃₀)alkenyl, and/or may not be (C₂-C₃₀)alkenyloxy, and/or may not be (C₂-C₃₀)alkynyl, and/or may not be (C₂-C₃₀)alkynyloxy, and/or may not be aryl, and/or may not be aryloxy, and/or may not be heteroaryl, and/or may not be heteroaryloxy, and/or may not be heterocyclyl, and/or may not be heterocyclyloxy, and/or may not be aryl(C₁-C₄)alkyl, and/or may not be aryl(C₁-C₄)alkoxy, and/or may not be heteroaryl(C₁-C₄)alkyl, and/or may not be heteroaryl(C₁-C₄)alkoxy, and/or may not be heterocyclyl(C₁-C₄)alkyl, and/or may not be heterocyclyl(C₁-C₄)alkoxy.

Examples of compounds of formula (VI) may include 1-cetylpyridinium chloride (“CPC”), which has the structural formula:

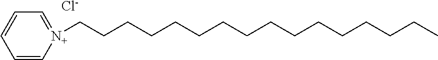 [SMILES: [Cl-] ; CCCCCCCCCCCCCCCC[n+]1ccccc1]

In yet another example, an additive compound may be a compound of formula (VII):

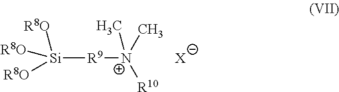

wherein X⁻ is as defined above for compounds of formula (I);

each R⁸ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl;

from Si to N, R⁹ is selected from the group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclylene, and (C₁-C₄)alkylheterocyclyl(C₁-C₄)alkylene; and

R¹⁰ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and

wherein the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy.

Certain examples of compounds of formula (VII) may include particular combinations of X⁻, R⁸, R⁹, and R¹⁰ that ultimately provide the surprising and unexpected effect of improved antimicrobial efficacy in antimicrobial thermoset coating formulations of the present disclosure, but not as efficiently as other particular combinations of X⁻, R⁹, R⁹, and R¹⁰ due to the combined effects of chemical phenomena understood by those skilled in the art, including, but not limited to, dipole moment, polarity, solubility, electronic effects, and/or steric effects resulting from the chemical structure of a particular compound of formula (VII). In certain examples of compounds of formula (VI), X⁻ may not be fluoride, and/or may not be chloride, and/or may not be bromide, and/or may not be iodide, and/or may not be hexafluorophosphate, and/or may not be sulfate, and/or may not be trifluoromethanesulfonate, and/or may not be an alkylsulfonate, and/or may not be an arylsulfonate. In certain examples of compounds of formula (VII), each R⁸, independently, may not be hydrogen, and/or may not be (C₁-C₃₀)alkyl, and/or may not be (C₂-C₃₀)alkenyl, and/or may not be (C₂-C₃₀)alkynyl, and/or may not be aryl(C₁-C₄)alkyl, and/or may not be heteroaryl(C₁-C₄)alkyl, and/or may not be heterocyclyl(C₁-C₄)alkyl, and/or may not be a substituted silyl. In certain examples of compounds of formula (VII), from Si to N, R⁹ may not be (C₁-C₃₀)alkylene, and/or may not be (C₂-C₃₀)alkenylene, and/or may not be (C₂-C₃₀)alkynylene, and/or may not be aryl(C₁-C₄)alkylene, and/or may not be (C₁-C₄)alkylarylene, and/or may not be (C₁-C₄)alkylaryl(C₁-C₄)alkylene, and/or may not be heteroaryl(C₁-C₄)alkylene, and/or may not be (C₁-C₄)alkylheteroarylene, and/or may not be (C₁-C₄)alkylheteroaryl(C₁-C₄)alkylene, and/or may not be heterocyclyl(C₁-C₄)alkylene, and/or may not be (C₁-C₄)alkylheterocyclylene, and/or may not be (C₁-C₄)alkylheterocyclyl(C₁-C₄)alkylene. In certain examples of compounds of formula (VII), R¹⁰ may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl. In certain examples of compounds of formula (VII), each substituent of a substituted silyl may not be hydrogen, and/or may not be (C₁-C₃₀)alkyl, and/or may not be (C₁-C₃₀)alkoxy, and/or may not be (C₂-C₃₀)alkenyl, and/or may not be (C₂-C₃₀)alkenyloxy, and/or may not be (C₂-C₃₀)alkynyl, and/or may not be (C₂-C₃₀)alkynyloxy, and/or may not be aryl, and/or may not be aryloxy, and/or may not be heteroaryl, and/or may not be heteroaryloxy, and/or may not be heterocyclyl, and/or may not be heterocyclyloxy, and/or may not be aryl(C₁-C₄)alkyl, and/or may not be aryl(C₁-C₄)alkoxy, and/or may not be heteroaryl(C₁-C₄)alkyl, and/or may not be heteroaryl(C₁-C₄)alkoxy, and/or may not be heterocyclyl(C₁-C₄)alkyl, and/or may not be heterocyclyl(C₁-C₄)alkoxy.

Examples of compounds of formula (VII) may include N-octadecyldimethyl-(3-(trimethoxysilyl)propyl)ammonium chloride (“HM 4072”) N-[3-(Trimethoxysilyl)propyl]-N,N,N-trimethylammonium chloride (“Trimethyl quat-silane”), and 4-(trimethoxysilylethyl)benzyltrimethylammonium chloride. N-Octadecyldimethy-(3-(trimethoxysilyl)propyl)ammonium chloride (HM 4072) has the structure formula:

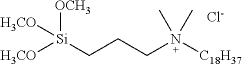

N-octadecyldimethyl-(3-(trimethoxysilyl)propyl)ammonium chloride (“HM 4072”).
   N-[3-(Trimethoxysilyl)propyl]-N,N,N-trimethylammonium chloride (Trimethyl quat-silane) has the structural formula:

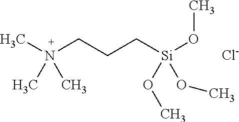

N-[3(Trimethoxysilyl)propyl]-N,N,N-trimethylammonium chloride (Trimethyl quat-silane).
   4-(Trimethoxysilylethyl)benzyltrimethylammonium chloride has the structural formula:

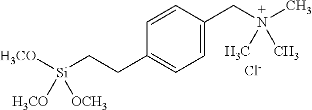

4-(Trimethoxysilylethyl)benzyltrimethylammonium chloride.

In an example, the present disclosure provides a thermo- or ultraviolet-curable resin, which may be a compound selected from the group consisting of polyacrylate, polyurea, polyurethane, aliphatic and aromatic urethanes, polyurea/polyurethane hybrids, urea-formaldehyde foam, diallylphthalate, polyimide, polyamide, bismaleimides, polyolefin, polystyrene, polycarbonate, polyethylene terephthalate (“PET”), polybutylene terephthalate (“PBT”), polyvinyl chloride (“PVC”), acrylonitrile butadiene styrene (“ABS”), benzoxazines, fluoropolymers, epoxy, phenolic resins, benzoxazines hybridized with epoxy and phenolic resins, melamine resins, polyesters, silicone resins, cyanate esters or polycyanurates, furan resins, vinyl ester resins, monomers thereof, oligomers thereof, polymers thereof, and any combinations or blends thereof.

Certain examples of antimicrobial thermoset coating formulations may include particular combinations of an additive compound and a thermo- or ultraviolet-curable resin that ultimately provide the surprising and unexpected effect of improved antimicrobial efficacy in antimicrobial thermoset coating formulations of the present disclosure, but not as efficiently as other particular combinations of an additive compound and a thermo- or ultraviolet-curable resin due to the combined effects of chemical phenomena understood by those skilled in the art, including, but not limited to, dipole moment, polarity, solubility, electronic effects, steric effects, and/or miscibility, as well as the relative stoichiometry of the additive compound and the thermo- or ultraviolet-curable resin. In certain examples of antimicrobial thermoset coating formulations, the thermo- or ultraviolet-curable resin may not polyacrylate, and/or may not be polyurea, and/or may not be polyurethane, and/or may not be an aliphatic urethane, and/or may not be an aromatic urethane, and/or may not be a polyurea/polyurethane hybrid, and/or may not be an urea-formaldehyde foam, and/or may not be diallylphthalate, and/or may not be polyimide, and/or may not be polyamide, and/or may not be a bismaleimide, and/or may not be polyolefin, and/or may not be polystyrene, and/or may not be polycarbonate, and/or may not be polyethylene terephthalate (PET), and/or may not be polybutylene terephthalate (PBT), and/or may not be polyvinyl chloride (PVC), and/or may not be acrylonitrile butadiene styrene (ABS), and/or may not be a benzoxazine, and/or may not be a fluoropolymer, and/or may not be an epoxy, and/or may not be a phenolic resin, and/or may not be a benzoxazine hybridized with an epoxy or phenolic resin, and/or may not be a melamine resin, and/or may not be a polyester, and/or may not be a silicone resin, and/or may not be a cyanate ester or polycyanurate, and/or may not be a furan resin, and/or may not be a vinyl ester resin, and/or may not be a monomer of a thermo- or ultraviolet-curable resin, and/or may not be an oligomer of a thermo- or ultraviolet-curable resin, and/or may not be a polymer of a thermo- or ultraviolet-curable resin, and/or may not be a combination of thermo- or ultraviolet-curable resins, and/or may not be a blend of thermo- or ultraviolet-curable resins.

Without being bound by theory, examples of additive compounds of the present disclosure may help to improve antimicrobial efficacy of antimicrobial thermoset coating formulations as a result of one or more of the following effects: (1) copper-ion extraction by coordination, chelation, and complexation; (2) increasing surface energy on a surface of an antimicrobial thermoset coating formulation; and/or (3) for quaternary ammonium (“QUAT”) based additive compounds, electrostatic attraction of negatively charged bacteria and/or viruses. Highest antimicrobial synergy was found when QUATs were used as additive compounds. Without being bound by theory, it is believed that the permanent positive charge of QUATs binds to the negatively charged surface membrane of most microorganisms, resulting in disrupting of the cell membrane of the microorganism and eventual lysis of the cell of the microorganism.

In operation, an antimicrobial thermoset coating formulation of the present disclosure may interact with and kill unwanted biological contaminants such as microbes in the formulation. Examples of microbes that an antimicrobial thermoset coating formulation of the present disclosure may kill may include, but are not limited to, Staphylococcus aureus, Enterobacter aerogenes, Pseudomonas aeruginosa, Methicillin Resistant E. coli, Enterobacter cloacae, Acinetobacter baumannii, Enterococcus faecalis, Klebsiella pneumoniae, Klebsiella aerogenes, Staphylococcus aureus, and mixtures thereof. Examples of viruses that an antimicrobial thermoset coating formulation of the present disclosure may kill may include, but are not limited to, Influenza H1N1, Adenovirus 5, Norovirus, and coronavirus. An example of a fungi that an antimicrobial thermoset coating formulation of the present disclosure may kill may include, but is not limited to, Candida auris. The effectiveness of an antimicrobial thermoset coating formulation may be measured as a function of the formulation's logarithmic reduction. The formulation's logarithmic reduction value may be relevant to the ability of the formulation to kill biological organisms to which the formulation is exposed. According to various examples, a logarithmic reduction of the formulation may be at least 3, at least about 4, at least about 5, at least about 6, at least about 7, at least about 8, at least about 9, at least about 10, in a range of from about 1 to about 10, about 3 to about 7, about 4 to about 6, or less than, equal to, or greater than about 3, 4, 5, 6, 7, 8, 9, or about 10. The logarithmic reduction can be measured according to the procedures outlined in the United States Environmental Protection Agency Office of Pesticide Programs Protocol for the Evaluation of Bactericidal Activity of Hard, Non-porous Copper Containing Surface Products, dated 29 Jan. 2016.

In an example of an antimicrobial thermoset coating formulation of the present disclosure, a copper-containing material may be included in examples of the antimicrobial thermoset coating formulations of the present disclosure in an amount of not more than 50 weight percent based on a total of 100 weight percent cumulatively for the formulation. In other examples of the antimicrobial thermoset coating formulations of the present disclosure, the copper-containing material may be included in an amount of not more than about 40 weight percent, or not more than about 38 weight percent, or not more than about 36 weight percent, or not more than about 34 weight percent, or not more than about 32 weight percent, or not more than about 30 weight percent, or not more than about 28 weight percent, or not more than about 26 weight percent, or not more than about 24 weight percent, or not more than about 22 weight percent, or not more than about 20 weight percent, or not more than about 18 weight percent, or not more than about 16 weight percent, or not more than about 14 weight percent, or not more than about 12 weight percent, or not more than about 10.0 weight percent, or not more than about 9.9 weight percent, or not more than about 9.8 weight percent, or not more than about 9.7 weight percent, or not more than about 9.6 weight percent, or not more than about 9.5 weight percent, or not more than about 9.4 weight percent, or not more than about 9.3 weight percent, or not more than about 9.2 weight percent, or not more than about 9.1 weight percent, or not more than about 9.0 weight percent, or not more than about 8.9 weight percent, or not more than about 8.8 weight percent, or not more than about 8.7 weight percent, or not more than about 8.6 weight percent, or not more than about 8.5 weight percent, or not more than about 8.4 weight percent, or not more than about 8.3 weight percent, or not more than about 8.2 weight percent, or not more than about 8.1 weight percent, or not more than about 8.0 weight percent, or not more than about 7.9 weight percent, or not more than about 7.8 weight percent, or not more than about 7.7 weight percent, or not more than about 7.6 weight percent, or not more than about 7.5 weight percent, or not more than about 7.4 weight percent, or not more than about 7.3 weight percent, or not more than about 7.2 weight percent, or not more than about 7.1 weight percent, or not more than about 7.0 weight percent, or not more than about 6.9 weight percent, or not more than about 6.8 weight percent, or not more than about 6.7 weight percent, or not more than about 6.6 weight percent, or not more than about 6.5 weight percent, or not more than about 6.4 weight percent, or not more than about 6.3 weight percent, or not more than about 6.2 weight percent, or not more than about 6.1 weight percent, or not more than about 6.0 weight percent, or not more than about 5.9 weight percent, or not more than about 5.8 weight percent, or not more than about 5.7 weight percent, or not more than about 5.6 weight percent, or not more than about 5.5 weight percent, or not more than about 5.4 weight percent, or not more than about 5.3 weight percent, or not more than about 5.2 weight percent, or not more than about 5.1 weight percent, or not more than about 5.0 weight percent, or not more than about 4.9 weight percent, or not more than about 4.8 weight percent, or not more than about 4.7 weight percent, or not more than about 4.6 weight percent, or not more than about 4.5 weight percent, or not more than about 4.4 weight percent, or not more than about 4.3 weight percent, or not more than about 4.2 weight percent, or not more than about 4.1 weight percent, or not more than about 4.0 weight percent, or not more than about 3.9 weight percent, or not more than about 3.8 weight percent, or not more than about 3.7 weight percent, or not more than about 3.6 weight percent, or not more than about 3.5 weight percent, or not more than about 3.4 weight percent, or not more than about 3.3 weight percent, or not more than about 3.2 weight percent, or not more than about 3.1 weight percent, or not more than about 3.0 weight percent, or not more than about 2.9 weight percent, or not more than about 2.8 weight percent, or not more than about 2.7 weight percent, or not more than about 2.6 weight percent, or not more than about 2.5 weight percent, or not more than about 2.4 weight percent, or not more than about 2.3 weight percent, or not more than about 2.2 weight percent, or not more than about 2.1 weight percent, or not more than about 2.0 weight percent, or not more than about 1.9 weight percent, or not more than about 1.8 weight percent, or not more than about 1.7 weight percent, or not more than about 1.6 weight percent, or not more than about 1.5 weight percent, or not more than about 1.4 weight percent, or not more than about 1.3 weight percent, or not more than about 1.2 weight percent, or not more than about 1.1 weight percent, or not more than about 1.0 weight percent, or not more than about 0.9 weight percent, or not more than about 0.8 weight percent, or not more than about 0.7 weight percent, or not more than about 0.6 weight percent, or not more than about 0.5 weight percent, or not more than about 0.4 weight percent, or not more than about 0.3 weight percent, or not more than about 0.2 weight percent, or not more than about 0.1 weight percent, or not more than 0 weight percent. In other examples, the copper-containing material may be included in a range from one of the above recited weight percents to another of the above recited weight percents.

In an example of an antimicrobial thermoset coating formulation of the present disclosure, an additive compound may be included in the examples of the antimicrobial thermoset coating formulations of the present disclosure in an amount of up to about 0.1 weight percent based on a total of 100 weight percent cumulatively for the formulation. In other examples of the antimicrobial thermoset coating formulations of the present disclosure, the additive compound may be included in an amount of up to 0.2 weight percent, or up to 0.3 weight percent, or up to 0.4 weight percent, or up to 0.5 weight percent, or up to 0.5 weight percent, or up to 0.6 weight percent, or up to 0.7 weight percent, or up to 0.8 weight percent, or up to 0.9 weight percent, or up to 1.0 weight percent, or up to 1.1 weight percent, or up to 1.2 weight percent, or up to 1.3 weight percent, or up to 1.4 weight percent, or up to 1.5 weight percent, or up to 1.6 weight percent, or up to 1.7 weight percent, or up to 1.8 weight percent, or up to 1.9 weight percent, or up to 2.0 weight percent, or up to 2.1 weight percent, or up to 2.2 weight percent, or up to 2.3 weight percent, or up to 2.4 weight percent, or up to 2.5 weight percent, or up to 2.6 weight percent, or up to 2.7 weight percent, or up to 2.8 weight percent, or up to 2.9 weight percent, or up to 3.0 weight percent, or up to 3.1 weight percent, or up to 3.2 weight percent, or up to 3.3 weight percent, or up to 3.4 weight percent, or up to 3.5 weight percent, or up to 3.6 weight percent, or up to 3.7 weight percent, or up to 3.8 weight percent, or up to 3.9 weight percent, or up to 4.0 weight percent, or up to 4.1 weight percent, or up to 4.2 weight percent, or up to 4.3 weight percent, or up to 4.4 weight percent, or up to 4.5 weight percent, or up to 4.6 weight percent, or up to 4.7 weight percent, or up to 4.8 weight percent, or up to 4.9 weight percent, or up to 5.0 weight percent, or up to 5.1 weight percent, or up to 5.2 weight percent, or up to 5.3 weight percent, or up to 5.4 weight percent, or up to 5.5 weight percent, or up to 5.6 weight percent, or up to 5.7 weight percent, or up to 5.8 weight percent, or up to 5.9 weight percent, or up to 6.0 weight percent, or up to 6.1 weight percent, or up to 6.2 weight percent, or up to 6.3 weight percent, or up to 6.4 weight percent, or up to 6.5 weight percent, or up to 6.6 weight percent, or up to 6.7 weight percent, or up to 6.8 weight percent, or up to 6.9 weight percent, or up to 7.0 weight percent, or up to 7.1 weight percent, or up to 7.2 weight percent, or up to 7.5 weight percent, or up to 7.6 weight percent, or up to 7.7 weight percent, or up to 7.8 weight percent, or up to 7.9 weight percent, or up to 8.0 weight percent, or up to 8.1 weight percent, or up to 8.2 weight percent, or up to 8.3 weight percent, or up to 8.4 weight percent, or up to 8.5 weight percent, or up to 8.6 weight percent, or up to 8.7 weight percent, or up to 8.8 weight percent, or up to 8.9 weight percent, or up to 9.0 weight percent, or up to 9.1 weight percent, or up to 9.2 weight percent, or up to 9.3 weight percent, or up to 9.4 weight percent, or up to 9.5 weight percent, or up to 9.6 weight percent, or up to 9.7 weight percent, or up to 9.8 weight percent, or up to 9.9 weight percent, or up to 10 weight percent, or up to 11 weight percent, or up to 12 weight percent, or up to 13 weight percent, or up to 14 weight percent, or up to 15 weight percent, or up to 16 weight percent, or up to 17 weight percent, or up to 18 weight percent, or up to 19 weight percent, or up to 20 weight percent. In other examples, the additive compound may be included in a range from one of the above recited weight percents to another of the above recited weight percents. In other examples, the above recited weight percents or ranges of weight percents may correspond to the cumulative weight percent of two or more different additive compounds.

In an example of an antimicrobial thermoset coating formulation of the present disclosure, cuprous oxide and/or cupric oxide may be included in the examples of the antimicrobial thermoset coating formulations of the present disclosure in an amount of up to about 0.1 weight percent based on a total of 100 weight percent cumulatively for the formulation. In other examples of the antimicrobial thermoset coating formulations of the present disclosure, cuprous oxide and/or cupric oxide may be included in an amount of up to 0.2 weight percent, or up to 0.3 weight percent, or up to 0.4 weight percent, or up to 0.5 weight percent, or up to 0.6 weight percent, or up to 0.7 weight percent, or up to 0.8 weight percent, or up to 0.9 weight percent, or up to 1.0 weight percent, or up to 1.1 weight percent, or up to 1.2 weight percent, or up to 1.3 weight percent, or up to 1.4 weight percent, or up to 1.5 weight percent, or up to 1.6 weight percent, or up to 1.7 weight percent, or up to 1.8 weight percent, or up to 1.9 weight percent, or up to 2.0 weight percent, or up to 2.1 weight percent, or up to 2.2 weight percent, or up to 2.3 weight percent, or up to 2.4 weight percent, or up to 2.5 weight percent, or up to 2.6 weight percent, or up to 2.7 weight percent, or up 2.8 weight percent, or up to 2.9 weight percent, or up to 3.0 weight percent, or up to 3.1 weight percent, or up to 3.2 weight percent, or up to 3.3 weight percent, or up to 3.4 weight percent, or up to 3.5 weight percent, or up to 3.6 weight percent, or up to 3.7 weight percent, or up to 3.8 weight percent, or up to 3.9 weight percent, or up to 4.0 weight percent, or up to 4.1 weight percent, or up to 4.2 weight percent, or up to 4.3 weight percent, or up to 4.4 weight percent, or up to 4.5 weight percent, or up to 4.6 weight percent, or up to 4.7 weight percent, or up to 4.8 weight percent, or up to 4.9 weight percent, or up to 5.0 weight percent, or up to 5.1 weight percent, or up to 5.2 weight percent, or up to 5.3 weight percent, or up to 5.4 weight percent, or up to 5.5 weight percent, or up to 5.6 weight percent, or up to 5.7 weight percent, or up to 5.8 weight percent, or up to 5.9 weight percent, or up to 6.0 weight percent, or up to 6.1 weight percent, or up to 6.2 weight percent, or up to 6.3 weight percent, or up to 6.4 weight percent, or up to 6.5 weight percent, or up to 6.6 weight percent, or up to 6.7 weight percent, or up to 6.8 weight percent, or up to 6.9 weight percent, or up to 7.0 weight percent, or up to 7.1 weight percent, or up to 7.2 weight percent, or up to 7.3 weight percent, or up to 7.4 weight percent, or up to 7.5 weight percent, or up to 7.6 weight percent, or up to 7.7 weight percent, or up to 7.8 weight percent, or up to 7.9 weight percent, or up to 8.0 weight percent, or up to 8.1 weight percent, or up to 8.2 weight percent, or up to 8.3 weight percent, or up to 8.4 weight percent, or up to 8.5 weight percent, or up to 8.6 weight percent, or up to 8.7 weight percent, or up to 8.8 weight percent, or up to 8.9 weight percent, or up to 9.0 weight percent, or up to 9.1 weight percent, or up to 9.2 weight percent, or up to 9.3 weight percent, or up to 9.4 weight percent, or up to 9.5 weight percent, or up to 9.6 weight percent, or up to 9.7 weight percent, or up to 9.8 weight percent, or up to 9.9 weight percent, or up to 10 weight percent, or up to 12 weight percent, or up to 14 weight percent, or up to 16 weight percent, or up to 18 weight percent, or up to 20 weight percent, or up to 22 weight percent, or up to 24 weight percent, or up to 26 weight percent, or up to 28 weight percent, or up to 30 weight percent, or up to 32 weight percent, or up to 34 weight percent, or up to 36 weight percent, or up to 38 weight percent, or up to 40 weight percent, or up to 42 weight percent, or up to 44 weight percent, or up to 46 weight percent, or up to 48 weight percent, or up to 50 weight percent. In other examples, cuprous oxide may be included in a range from one of the above recited weight percents to another of the above recited weight percents.

In an example of an antimicrobial thermoset coating formulation of the present disclosure, a thermo- or UV-curable resin may be included in the examples of the antimicrobial thermoset coating formulations of the present disclosure in an amount to total 100 weight percent cumulatively for the formulation in combination with the amounts of additive compound, or in combination with the amounts of additive compound and cuprous oxide, or in combination with the amounts of additive compound and copper-containing material. In other examples of the antimicrobial thermoset coating formulations of the present disclosure, the thermo- or UV-curable resin may be included in an amount of not less than 50 weight percent, or not less than 51 weight percent, or not less than 52 weight percent, or not less than 53 weight percent, or not less than 54 weight percent, or not less than 55 weight percent, or not less than 56 weight percent, or not less than 57 weight percent, or not less than 58 weight percent, or not less than 59 weight percent, or not less than 60 weight percent, or not less than 61 weight percent, or not less than 62 weight percent, or not less than 63 weight percent, or not less than 64 weight percent, or not less than 65 weight percent, or not less than 66 weight percent, or not less than 67 weight percent, or not less than 68 weight percent, or not less than 69 weight percent, or not less than 70 weight percent, or not less than 71 weight percent, or not less than 72 weight percent, or not less than 73 weight percent, or not less than 74 weight percent, or not less than 75 weight percent, or not less than 76 weight percent, or not less than 77 weight percent, or not less than 78 weight percent, or not less than 79 weight percent, not less than 80 weight percent, or not less than 81 weight percent, or not less than 82 weight percent, or not less than 83 weight percent, or not less than 84 weight percent, or not less than 85 weight percent, or not less than 86 weight percent, or not less than 87 weight percent, or not less than 88 weight percent, or not less than 89 weight percent, or not less than 90 weight percent, or not less than 90.1 weight percent, or not less than 90.2 weight percent, or not less than 90.3 weight percent, or not less than 90.4 weight percent, or not less than 90.5 weight percent, or not less than 90.6 weight percent, or not less than 90.7 weight percent, or not less than 90.8 weight percent, or not less than 90.9 weight percent, or not less than 91.0 weight percent, or not less than 91.1 weight percent, or not less than 91.2 weight percent, or not less than 91.3 weight percent, or not less than 91.4 weight percent, or not less than 91.5 weight percent, or not less than 91.6 weight percent, or not less than 91.7 weight percent, or not less than 91.8 weight percent, or not less than 91.9 weight percent, or not less than 92.0 weight percent, or not less than 92.1 weight percent, or not less than 92.2 weight percent, or not less than 92.3 weight percent, or not less than 92.4 weight percent, or not less than 92.5 weight percent, or not less than 92.6 weight percent, or not less than 92.7 weight percent, or not less than 92.8 weight percent, or not less than 92.9 weight percent, or not less than 93.0 weight percent, or not less than 93.1 weight percent, or not less than 93.2 weight percent, or not less than 93.3 weight percent, or not less than 93.4 weight percent, or not less than 93.5 weight percent, or not less than 93.6 weight percent, or not less than 93.7 weight percent, or not less than 93.8 weight percent, or not less than 93.9 weight percent, or not less than 94.0 weight percent, or not less than 94.1 weight percent, or not less than 94.2 weight percent, or not less than 94.3 weight percent, or not less than 94.4, weight percent, or not less than 94.5 weight percent, or not less than 94.6 weight percent, or not less than 94.7 weight percent, or not less than 94.8 weight percent, or not less than 94.9 weight percent, or not less than 95.0 weight percent, or not less than 95.1 weight percent, or not less than 95.2 weight percent, or not less than 95.3 weight percent, or not less than 95.4 weight percent, or not less than 95.5 weight percent, or not less than 95.6 weight percent, or not less than 95.7 weight percent, or not less than 95.8 weight percent, or not less than 95.9 weight percent, or not less than 96.0 weight percent, or not less than 96.1 weight percent, or not less than 96.2 weight percent, or not less than 96.3 weight percent, or not less than 96.4 weight percent, or not less than 96.5 weight percent, or not less than 96.6 weight percent, or not less than 96.7 weight percent, or not less than 96.8 weight percent, or not less than 96.9 weight percent, or not less than 97.0 weight percent, or not less than 97.1 weight percent, or not less than 97.2 weight percent, or not less than 97.3 weight percent, or not less than 97.4 weight percent, or not less than 97.5 weight percent, or not less than 97.6 weight percent, or not less than 97.7 weight percent, or not less than 97.8 weight percent, or not less than 97.9 weight percent, or not less than 98.0 weight percent, or not less than 98.1 weight percent, or not less than 98.2 weight percent, or not less than 98.3 weight percent, or not less than 98.4 weight percent, or not less than 98.5 weight percent, or not less than 98.6 weight percent, or not less than 98.7 weight percent, or not less than 98.8 weight percent, or not less than 98.9 weight percent, or not less than 99.0 weight percent. In other examples, the thermo- or UV-curable resin may be included in a range from one of the above recited weight percents to another of the above recited weight percents.

In an example, the present disclosure provides an antimicrobial system, including: a reservoir including a dispersion of an antimicrobial thermoset coating formulation; a disperser fluidly connected to the reservoir configured to apply the antimicrobial thermoset coating formulation to a surface; and a heat or ultraviolet radiation source configured to cure the antimicrobial thermoset coating formulation after the antimicrobial thermoset coating formulation is applied to the surface; wherein the antimicrobial thermoset coating formulation includes: an additive compound in an amount from up to 0.1 to 20 weight %; and a thermo- or UV-curable resin in an amount to total 100 weight % for the formulation.

### Preparation of Antimicrobial Thermoset Coating Formulations

In certain examples, generally solvent-based chemical laboratory techniques may be employed in the processes to prepare the examples of the antimicrobial thermoset coating formulations of the present disclosure. In other examples, generally solvent-free chemical laboratory techniques may be employed in the processes to prepare the examples of the antimicrobial thermoset coating formulations of the present disclosure.

In an example, a method of preparing an antimicrobial thermoset coating formulation is provided. The antimicrobial thermoset coating formulations may be prepared by a method including: (a) adding an amount of thermo- or UV-curable resin to an amount of a copper-containing material; (b) adding an amount of additive compound to the amount of the copper-containing and the amount of thermo- or UV-curable resin to provide a dispersion; (c) agitating the dispersion; (d) applying the dispersion along an upper edge of a surface of a substrate secured under a vacuum to a surface of a screen separator at an elevated temperature until the dispersion coats the surface; (e) releasing the vacuum; and (f) curing the film with a UV lamp to provide the antimicrobial thermoset coating formulation. In certain examples, the agitating may performed for a duration of at least 2 hours. In other examples, the elevated temperature may be a temperature of at least 50° C. In other examples, the curing may be performed at a dose of at least 1000 mJ/cm².

In another example, a method of preparing an antimicrobial thermoset coating formulation is provided. The antimicrobial thermoset coating formulations may be prepared by a method including: (a) diluting an amount of an additive compound with a solvent in a vessel to provide an additive compound solution; (b) adding an amount of the copper-containing glass particles to the additive compound solution to provide a mixture; (c) sonicating the mixture; (d) adding an amount of thermo- or UV-curable resin to the mixture to provide a dispersion; (e) agitating the dispersion; (f) applying the dispersion along an upper edge of a surface of a substrate secured under a vacuum to a surface of a screen separator at an elevated temperature until the dispersion coats the surface; (g) releasing the vacuum; and (h) curing the film with a UV lamp to provide the antimicrobial thermoset coating formulation. In certain examples, the sonicating may be performed for at least 15 minutes.

Preferred solvents for diluting an additive compound may include, but are not limited to: alcohols, particularly alcohols containing up to four carbon atoms such as methanol, ethanol, isopropanol, butan-1-ol, butan-2-ol, and 2-methyl-2-propanol; ethers, for example diethyl ether, diisopropyl ether, t-butyl methyl ether, 1,2-dimethoxyethane, tetrahydrofuran, and 1,4-dioxane; hydrocarbon solvents, for example pentane, hexane, and toluene; and mixtures thereof. Pure solvents, preferably at least analytical grade, and more preferably pharmaceutical grade, are preferably used.

In yet another example, a method of preparing an antimicrobial thermoset coating formulation is provided. The antimicrobial thermoset coating formulation may be prepared by a method including (a) adding an amount of an additive compound to an amount of cuprous oxide and an amount of thermo- or UV-curable resin to provide a dispersion; (b) agitating the dispersion; (c) applying the dispersion along an upper edge of a surface of a substrate secured under a vacuum to a surface of a screen separator at an elevated temperature until the dispersion coats the surface; (e) drawing the dispersion down the surface to form a film using a wet film applicator; (f) releasing the vacuum; (g) curing the film with a UV lamp to provide the antimicrobial thermoset coating formulation.

In yet another example, a method of preparing an antimicrobial thermoset coating formulation is provided. The antimicrobial thermoset coating formulation may be prepared by a method including (a) adding an amount of an additive compound to an amount of thermo- or UV-curable resin to provide a dispersion; (b) agitating the dispersion; (c) applying the dispersion along an upper edge of a surface of a substrate secured under a vacuum to a surface of a screen separator at an elevated temperature until the dispersion coats the surface; (d) releasing the vacuum; and (e) curing the film with a UV lamp to provide the antimicrobial thermoset coating formulation.

In yet another example, a method of preparing an antimicrobial thermoset coating formulation is provided, including: (a) adding from up to 0.1 to 20 weight % of an additive compound to an amount of thermo- or UV-curable resin in an amount to total 100 weight % for the formulation to provide a dispersion; (b) agitating the dispersion; (c) applying the dispersion along an upper edge of a surface of a substrate secured vertically under a vacuum to a surface of a screen separator at an elevated temperature until the dispersion coats the surface; (d) releasing the vacuum; and (e) curing the film with a UV lamp to provide the antimicrobial thermoset coating formulation. In yet another example, a method of preparing an antimicrobial thermoset coating formulation is provided, further including: adding a copper-containing material in an amount from up to 0.1 to 5.0 weight % to the thermo- or UV-curable resin in the vessel prior to the adding of the amount of the additive compound. In yet another example, a method of preparing an antimicrobial thermoset coating formulation is provided, wherein the copper-containing material is cuprous oxide.

A screen separator is a device that may be conventionally used to separate a glass cover from a lithium crystal display (“LCD”) screen. The screen separator may use a vacuum to secure the glass to a surface of a screen separator at a temperature above ambient temperature. Examples of screen separators may include a YiHUA 946A screen separator, or the like.

A wet film applicator is a device that may be conventionally used for laying down wet films of materials of predetermined thicknesses. The wet film applicator may be fabricated from hardened and ground steel machined to a fine tolerance. A wet film thickness is a nominal thickness of a coating when drawn down. The wet film thickness is conventionally one-half of a Cut, which is the actual gap clearance (depth) of the wet film applicator. For example, a wet film applicator with a 1 mil (0.001″) Cut Depth will lay down a wet film thickness of 0.5 mil (0.0005″). Examples of wet film applicators may include a Bird Film Applicator®, or the like.

The formulations and methods described above may be better understood in connection with the following Examples. In addition, the following non-limiting examples are an illustration. The illustrated methods are applicable to other examples of antimicrobial thermoset coating formulations of the present disclosure. The procedures described as general methods describe what is believed will be typically effective to prepare the formulations indicated. However, the person skilled in the art will appreciate that it may be necessary to vary the procedures for any given example of the present disclosure, e.g, vary the order or steps and/or the chemical reagents used.

### EXAMPLES

General procedure for preparation of antimicrobial thermoset coating formulation dispersions. In the below examples, a copper-containing material may include from 10 weight % to 70 weight % extractable copper.

Comparison Examples 1-2. A copper-containing material and thermo- or UV-curable resin were added into a container. The copper-containing material dispersion was thoroughly agitated by shaking, then the dispersion was placed in a vessel with a rotor and agitated continuously for 2 hours.

Examples 1-25. A copper-containing material and thermo- or UV-curable resin were added into a container. The dispersion of the copper-containing material was thoroughly agitated by shaking, then the dispersion was placed in a vessel with a rotor and agitated continuously for 2 hours.

Examples 26-29. N-Octadecyldimethyl-(3-(trimethoxysilyl)propyl)ammonium chloride (HM 4072) or N-[3-(Trimethoxysilyl)propyl]-N,N,N-trimethylammonium chloride (Trimethyl quat-silane) is diluted with ethanol and mixed with a copper-containing material. The corresponding copper-containing material and quat-silane mixtures were sonicated for 15 minutes at ambient temperature. Thermo- or UV-curable resin was added into the mixtures then the mixtures were thoroughly agitated by shaking, then placed in a vessel with a rotor and agitated continuously for 2 hours.

Examples 30-31. Cuprous oxide (Cu₂O) and thermo- or UV-curable resin were added into a container, followed by adding additive compound. The dispersion was thoroughly agitated by shaking, then placed in a vessel with a rotor and agitated continuously for 2 hours.

General Procedure for Curing of Antimicrobial Thermoset Coating Formulation dispersions to form antimicrobial thermoset coating formulations.

Glass sheets measuring 6 inches by 6 inches were secured via vacuum to the surface of a YiHUA 946A screen separator, and the heat was set to 50° C. An antimicrobial thermoset coating formulation dispersion was applied along the upper edge of a glass sheet and subsequently drawn down to form a film using a 1 mil Bird Film Applicator®. The vacuum was released, and the glass part was removed from the screen separator, and the corresponding coating part was cured in a UV chamber. Ultraviolet-curing was performed with a Hg (H) type UV lamp with a minimum dose of 1000 mJ/cm². Thermo-curing was performed by placing a coated substrate in an oven preheated to 150° C. for 30 minutes.

### General Procedure for Environmental Protection Agency (“EPA”) Microbial Testing.

Stainless steel carriers, used as a reference, were cleaned and sterilized by immersion in a 75% ethanol solution followed by rinsing with deionized water. Vials containing Staphylococcus aureus (ATCC 6538) bacterial stock culture were stored at −80° C. until use. Aliquots of 20 μL of thawed bacterial cultures were added to 10 milliliters of Tryptic Soy Broth (Teknova). These bacterial suspensions were serially incubated three times at 36° C. for 18-24 hours in an orbital shaker (New Brunswick Scientific), and then one time in polypropylene snap tubes (Fisher Healthcare) for 48 hours. Cultures were subsequently mixed on a vortex mixer (VWR Scientific) and allowed to settle. The upper two-thirds of suspension from each tube was aspirated and OD₆₀₀ was measured (Smart Spec Spectrophotometer 3000, Bio-Rad) for bacterial density estimation. The culture was diluted with phosphate buffer saline (Gibco Life Technologies) to achieve a bacterial inoculum concentration near a target value of 1.0·10⁷ CFU/mL. Fetal bovine serum (0.25 mL of 5%, Gibco Life Technologies) and 0.05 mL Triton X-100 (Amresco Pro Pure) were added to 4.70 mL bacterial suspension to aid in spreading the inoculum. Each test coupon (area of 1 inch by 1 inch) was inoculated with 20 μL of the bacterial test culture. The inoculum volume was spread evenly using bent sterile pipette tips (Mettler-Toledo) to ensure full and even coverage, spreading as close to the edge of the coupon as possible. Coupons were then incubated in a controlled environment set at 42% relative humidity and 23° C. for a period of 120 minutes. Following the 120-minute exposure period, coupons were neutralized in Letheen broth (Gen Lab). Ten-fold serial dilutions of the neutralized solutions were plated using standard spread plate technique on Tryptic Soy Agar plates and incubated for 24 hours at 36° C. to yield countable numbers of survivors (approximately 20-200 colonies per plate). Log and percentage of reductions for bactericidal efficacy tests measure differences in CFUs between stainless steel and glass containing coupons. For an antimicrobial thermoset coating formulation to be considered a sanitizer, a ≥99.9% reduction (≥3 log reduction) must be demonstrated.

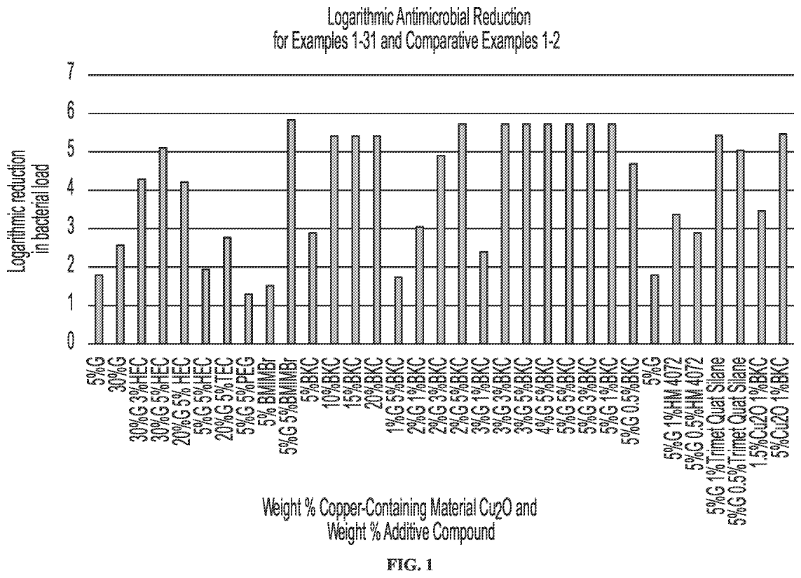

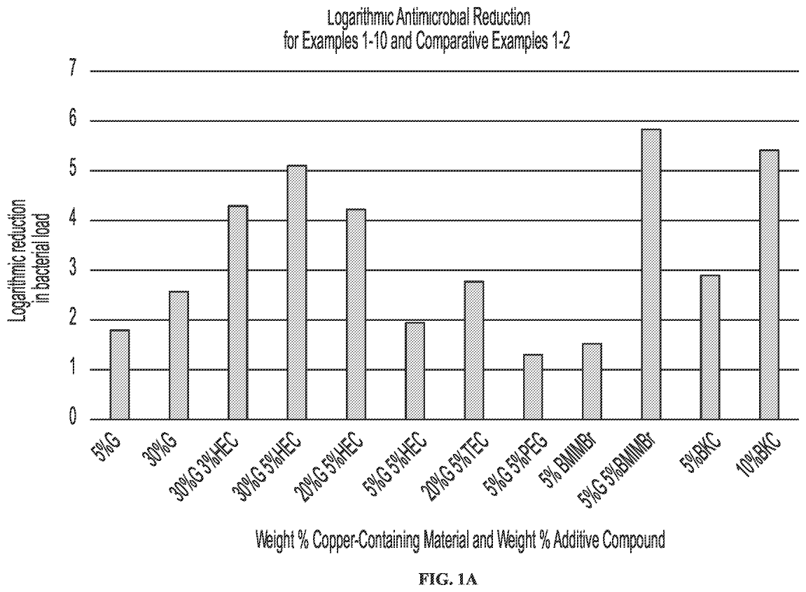

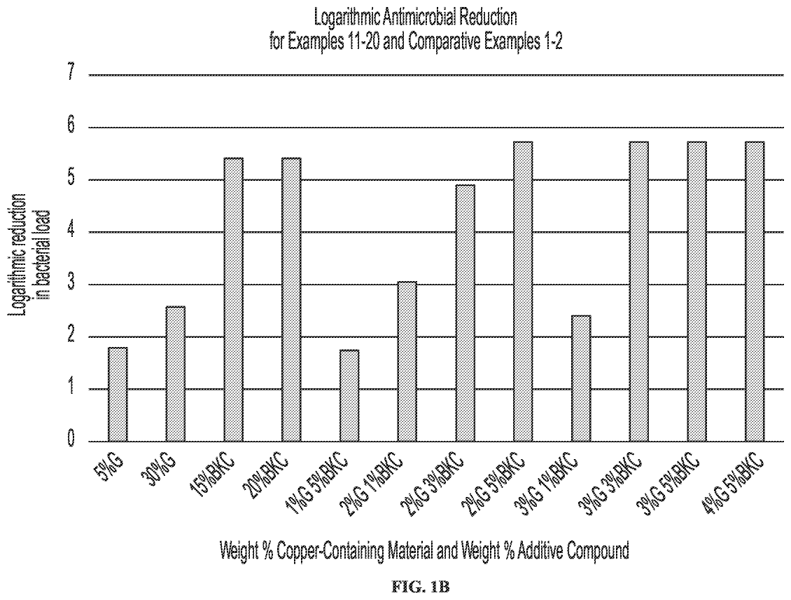

The amounts of each component in the examples of antimicrobial thermoset coating formulation dispersions, from which the examples of antimicrobial thermoset coating formulations were prepared, are included in Table 1 below. Additionally, Table 1 includes the % reduction and logarithmic reduction of Staphylococcus aureus for the EPA microbial testing of each example of antimicrobial thermoset coating formulation listed in Table 1. Comparison examples 1 and 2 included no additive compound and demonstrated less than 99.9% reduction (less than 3 logarithmic reduction) in bacterial load. As demonstrated by Table 1, and FIGS. 1 and 1A, Examples 1-3, with 20 weight % or greater of a copper-containing material, demonstrated greater than 99.9% reduction (greater than 3 logarithmic reduction) in bacterial load. Examples 8, 14-16, 18-24, 26, and 28-29, as shown in FIGS. 1B and 1C, unexpectedly demonstrated that greater than 99.9% reduction (greater than 3 logarithmic reduction) in bacterial load was obtained by using a copper-containing material in an amount of from 1 to 5 weight % in combination with an additive compound in an amount of from 1 to 5 weight %, which demonstrates synergistic antimicrobial efficacy of the copper-containing material, which may be present in much lower weight %, when combined with an additive compound over and above antimicrobial efficacy of higher amounts of the copper-containing material absent the additive compound. Likewise, examples 10-12 unexpectedly demonstrated that greater than 99.9% reduction (greater than 5 logarithmic reduction) in bacterial load could be obtained in the absence of the copper-containing material. Examples 30-31 unexpectedly demonstrated that greater than 99.90 reduction (greater than 3 logarithmic reduction) in bacterial load was obtained by using 1.5 or 5 weight 00 of cuprous oxide in combination with 1 weight 00 additive compound.

Table 1 demonstrates that good antimicrobial efficacy (>3 log kill) was achieved with at least 30 weight 00 of a copper-containing material. However, addition of quaternary ammonium (“QUAT”)-based, 1-butyl-3-methylimidazolium bromide (BMIMBr), or benzalkonium chloride (BKC) additive compound effectively improved antimicrobial efficacy of antimicrobial thermoset coating formulations while requiring far less weight 00 copper-containing material, demonstrating synergistic antimicrobial efficacy. In particular, benzalkonium chloride (BKC), EPA-registered QUAT biocide, resulted in the very strong antimicrobial synergy (>5 log-kill) with only 2 weight 00 of a copper-containing material (Example 16, Table 1).

TABLE 1

| | Copper ion (wt.%) | | | | UV- | | AM |
|---|---|---|---|---|---|---|---|
| | Copper-containing | | | | curable | AM | log- |
| | material | | Additive compound | | resin | % kill | kill |
| | | Cu₂O | Compound | wt. % | (wt. %) | (Staph A.) | (Staph A.) |
| Comparison | 5 | — | — | — | 95 | 98.40 | 1.79 |
| Example 1 | | | | | | | |
| Comparison | 30 | — | — | — | 70 | 99.74 | 2.57 |
| Example 2 | | | | | | | |
| Example 1 | 30 | — | hydroxyethyl | 3 | 67 | >99.99 | 4.29 |
| | | | cellulose | | | | |
| Example 2 | 30 | — | hydroxyethyl | 5 | 65 | >99.999 | 5.1 |
| | | | cellulose | | | | |
| Example 3 | 20 | — | hydroxyethyl | 5 | 75 | >99.99 | 4.22 |
| | | | cellulose | | | | |
| Example 4 | 5 | — | hydroxyethyl | 5 | 90 | 98.83 | 1.94 |
| | | | cellulose | | | | |
| Example 5 | 20 | — | triethyl citrate | 5 | 75 | 99.83 | 2.77 |
| Example 6 | 5 | — | polyethylene | 5 | 90 | 94.90 | 1.3 |
| | | | glycol | | | | |
| Example 7 | — | — | 1-butyl-3- | 5 | 95 | 96.95 | 1.52 |
| | | | methylimidazolium | | | | |
| | | | bromide | | | | |
| Example 8 | 5 | — | 1-butyl-3- | 5 | 90 | >99.999 | 5.83 |
| | | | methylimidazolium | | | | |
| | | | bromide | | | | |
| Example 9 | — | — | benzalkonium | 5 | 95 | 99.87 | 2.89 |
| | | | chloride | | | | |
| Example 10 | — | — | benzalkonium | 10 | 90 | >99.999 | 5.41 |
| | | | chloride | | | | |
| Example 11 | — | — | benzalkonium | 15 | 85 | >99.999 | 5.41 |
| | | | chloride | | | | |
| Example 12 | — | — | benzalkonium | 20 | 80 | >99.999 | 5.41 |
| | | | chloride | | | | |
| Example 13 | 1 | — | benzalkonium | 5 | 94 | 98.17 | 1.74 |
| | | | chloride | | | | |
| Example 14 | 2 | — | benzalkonium | 1 | 97 | 99.91 | 3.05 |
| | | | chloride | | | | |
| Example 15 | 2 | — | benzalkonium | 3 | 95 | >99.99 | 4.90 |
| | | | chloride | | | | |
| Example 16 | 2 | — | benzalkonium | 5 | 93 | >99.999 | 5.72 |
| | | | chloride | | | | |
| Example 17 | 3 | — | benzalkonium | 1 | 96 | 99.60 | 2.4 |
| | | | chloride | | | | |
| Example 18 | 3 | — | benzalkonium | 3 | 94 | >99.999 | 5.72 |
| | | | chloride | | | | |
| Example 19 | 3 | — | benzalkonium | 5 | 92 | >99.999 | 5.72 |
| | | | chloride | | | | |
| Example 20 | 4 | — | benzalkonium | 5 | 91 | >99.999 | 5.72 |
| | | | chloride | | | | |
| Example 21 | 5 | — | benzalkonium | 5 | 90 | >99.999 | 5.72 |
| | | | chloride | | | | |
| Example 22 | 5 | — | benzalkonium | 3 | 92 | >99.999 | 5.72 |
| | | | chloride | | | | |
| Example 23 | 5 | — | benzalkonium | 1 | 94 | >99.999 | 5.72 |
| | | | chloride | | | | |
| Example 24 | 5 | — | benzalkonium | 0.5 | 94.5 | >99.99 | 4.69 |
| | | | chloride | | | | |
| Example 25 | 5 | — | benzalkonium | 0 | 95 | 98.38 | 1.79 |
| | | | chloride | | | | |
| Example 26 | 5 | — | HM 4072 | 1 | 94 | 99.96 | 3.37 |
| Example 27 | 5 | — | HM 4072 | 0.5 | 94.5 | 99.87 | 2.89 |
| Example 28 | 5 | — | Trimethyl quat- | 1 | 94 | >99.999 | 5.43 |
| | | | silane | | | | |
| Example 29 | 5 | — | Trimethyl quat- | 0.5 | 94.5 | >99.999 | 5.04 |
| | | | silane | | | | |
| Example 30 | — | 1.5 | benzalkonium | 1 | 97.5 | 99.97 | 3.46 |
| | | | chloride | | | | |
| Example 31 | — | 5 | benzalkonium | 1 | 94 | >99.999 | 5.46 |
| | | | chloride | | | | |

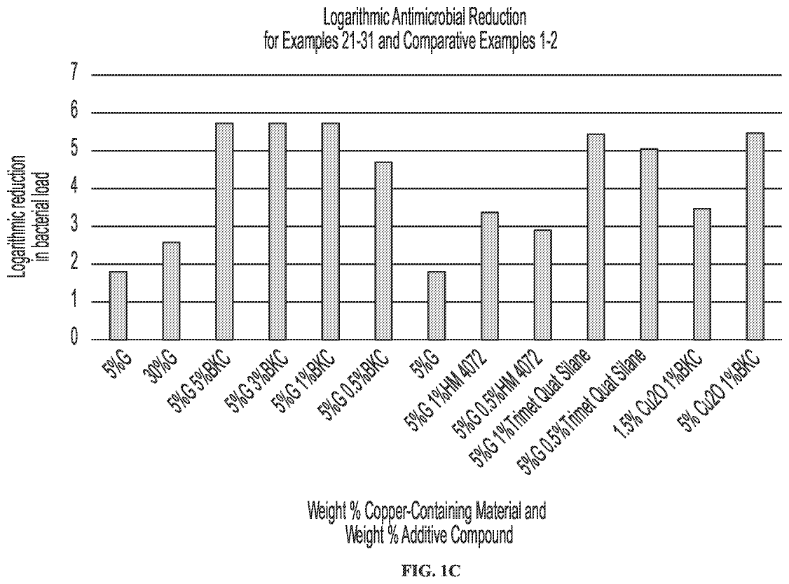

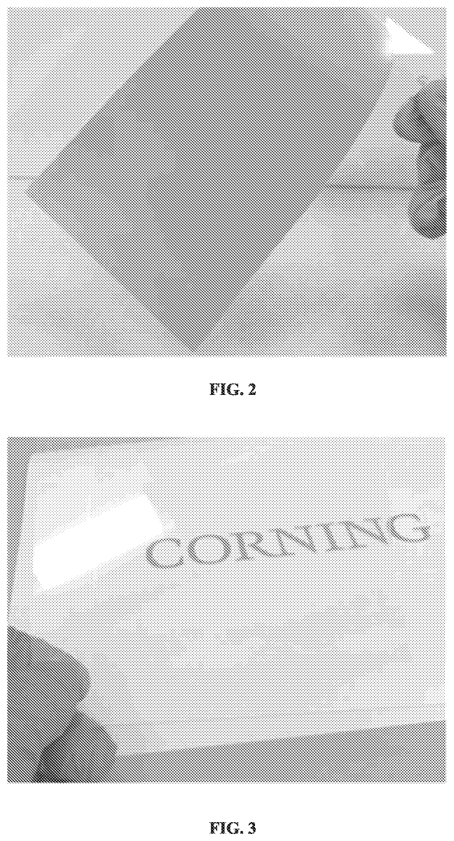

FIG. 2 illustrates a photograph of an antimicrobial thermoset coating formulation including 30 wt. 00 copper-containing material prepared according to Comparison Example 2 of the present disclosure. By contrast, FIG. 3 illustrates a photograph of an antimicrobial thermoset coating including 2 wt. 00 copper-containing material prepared according to Example 16 of Table 1 of the present disclosure. FIG. 2 demonstrates the lack of clarity and orange color in a coating formulation associated with a 30 weight 00 loading of copper-containing material. By contrast, FIG. 3 indicates that a much lower loading of copper-containing material advantageously provides a clear, less colored coating formulation. The difference between FIGS. 2 and 3 demonstrate that the synergistic effect of the combination of the additive compound with the copper-containing material and the thermo- or UV-curable resin can effectively reduce loading of the copper-containing material loading with the same or better antimicrobial efficacy as without the additive compound and/or without reducing the loading of the copper-containing material.

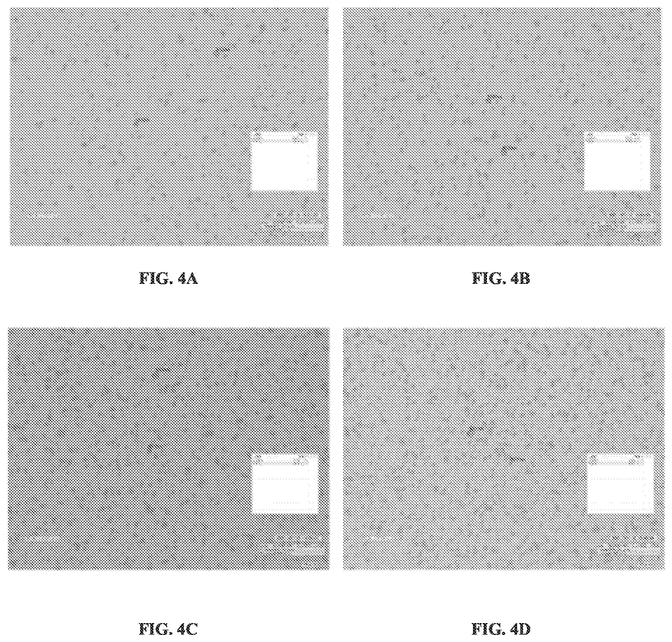

FIGS. 4A, 4B, 4C, and 4D illustrate microscope surface images of antimicrobial thermoset coatings including 100-μm scale bars, prepared according to Examples 16, 19, 20, and 21 of Table 1, respectively. FIGS. 4A, 4B, 4C, and 4D illustrate that the coated formulations maintain a consistent antimicrobial efficacy as the additive is maintained at 5 weight % while the copper-containing material weight percent is increased from 2 weight % to 5 weight %.

It is expected that antimicrobial efficacy testing of additional examples of antimicrobial thermoset coating formulations will demonstrate more durable and non-leachable quaternary-functionalized copper-containing material. It is believed that the siloxane function of compounds of formula (VII) could form covalent bonding on the surface of particles of the copper-containing material. Preliminary results of this additional testing is demonstrated by examples 26-29 as shown in Table 1.

Although the present disclosure has been described with reference to examples and the accompanying figures and charts, the present disclosure is not limited thereto, but may be variously modified and altered by those skilled in the art to which the present disclosure pertains without departing from the spirit and scope of the present disclosure.

The subject-matter of the disclosure may also relate, among others, to the following aspects:

A first aspect relates to an antimicrobial thermoset coating formulation, comprising: a copper-containing material in an amount from up to 0.1 to 30 weight %; an additive compound in an amount from up to 0.1 to 20 weight %; and a thermo- or UV-curable resin in an amount to total 100 weight % for the formulation.

A second aspect relates to the antimicrobial thermoset coating formulation of aspect 1, wherein the copper-containing material is cuprous oxide and/or cupric oxide.

A third aspect relates to the antimicrobial thermoset coating formulation of any preceding aspect, wherein the additive compound is a compound of formulae (I), (II), (III), (IV), (V), (VI), or (VII):

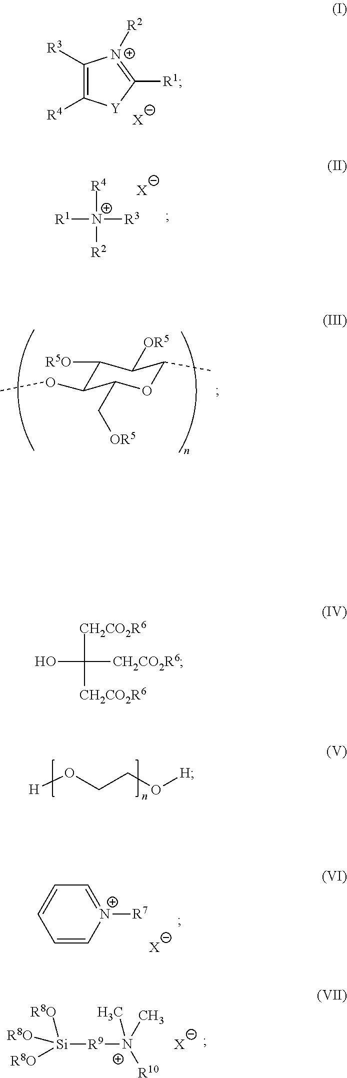

wherein X⁻ is selected from the group consisting of fluoride, chloride, bromide, iodide, hexafluorophosphate, sulfate, trifluoromethanesulfonate, an alkylsulfonate, and an arylsulfonate;
Y is selected from the group consisting of S, S(O), SO₂, NR¹, and PR¹;
each of R¹, R², R³, and R⁴ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl;
the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenoxy, (C₂-C₃₀)alkynyl, (C₂-C₃₀)alkynyl, (C₂-C₃₀)alkynoxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy
R⁵ is selected from the group consisting of hydrogen, (C₁-C₃₀)alkyl, aryl, —CH₂CH₂OH, and —CH₂Co₂H;
the molecular weight of the compound of formula (III) is from 5000 g/mole to 1·10⁶ g/mole;
each R⁶ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl;
the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocylyloxy, aryl(C₁-C₄)alkyl, aryl(C₁-C₄)alkoxy, heteroaryl(C₁-C₄)alkyl, hetero(C₁-C₄)alkoxy, heterocyclyl(C₁-C₄)alkyl, and heterocyclyl(C₁-C₄)alkoxy;
the molecular weight of the compound of formula (V) is from 1000 g/mole to 50000 g/mole;
R⁷ is selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl;
each R⁸ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl;
from Si to N, R⁹ is selected from the group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclylene, and (C₁-C₄)alkylheterocyclyl(C₁-C₄)alkylene; and R¹⁰ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl.

A fourth aspect relates to the antimicrobial thermoset coating formulation of any preceding aspect, wherein the additive compound is 1-butyl-3-methylimidazolium bromide, didecyldimethyl ammonium chloride, and/or 1-cetylpyridinium chloride.

A fifth aspect relates to the antimicrobial thermoset coating formulation of any one of aspects 1 to 3, wherein the additive compound is hydroxyethyl cellulose and/or carboxymethyl cellulose.

A sixth aspect relates to the antimicrobial thermoset coating formulation of any one of aspects 1 to 3, wherein the additive compound is triethyl citrate.

A seventh aspect relates to the antimicrobial thermoset coating formulation of any one of aspects 1 to 3, wherein the additive compound is N-octadecyldimethyl-(3-(trimethoxysilyl)propyl)ammonium chloride, 4-(trimethoxysilylethyl)benzyltrimethylammonium chloride, and/or N-[3-(Trimethoxysilyl)propyl]-N,N,N-trimethylammonium chloride.

An eighth aspect relates to the antimicrobial thermoset coating formulation of any one of aspects 1 to 3, wherein the additive compound is a benzalkonium chloride of the formula:

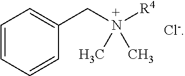

A ninth aspect relates to the antimicrobial thermoset coating formulation of any preceding aspect, wherein the thermo- or UV-curable resin is selected from the group consisting of polyacrylate, polyurea, polyurethane, aliphatic and aromatic urethanes, polyurea/polyurethane hybrids, urea-formaldehyde foam, diallylphthalate, polyimide, polyamide, bismaleimides, polyolefin, polystyrene, polycarbonate, polyethylene terephthalate, polybutylene terephthalate, polyvinyl chloride, acrylonitrile butadiene styrene, benzoxazines, fluoropolymers, epoxy, phenolic resins, benzoxazines hybridized with epoxy and phenolic resins, melamine resins, polyesters, silicone resins, cyanate esters or polycyanurates, furan resins, vinyl ester resins, monomers thereof, oligomers thereof, polymers thereof, and any combination or blend thereof.

A tenth aspect relates to an antimicrobial system, comprising: a reservoir comprising a dispersion of an antimicrobial thermoset coating formulation of any preceding aspect; a disperser fluidly connected to the reservoir configured to apply the antimicrobial thermoset coating formulation to a surface; and a heat or ultraviolet radiation source configured to cure the antimicrobial thermoset coating formulation after the antimicrobial thermoset coating formulation is applied to the surface.

An eleventh aspect relates to a method of preparing an antimicrobial thermoset coating formulation, comprising: adding from up to 0.1 to 20 weight % of an additive compound to a thermo- or UV-curable resin in an amount to total 100 weight % for the formulation to provide a dispersion; agitating the dispersion; applying the dispersion to a surface of a substrate until the dispersion coats the surface of the substrate; and curing the film with a UV lamp to provide the antimicrobial thermoset coating formulation.

A twelfth aspect relates to the method of aspect 11, further comprising: adding a copper-containing material in an amount from up to 0.1 to 30 weight % to the thermo- or UV-curable resin prior to the adding of the additive compound.

A thirteenth aspect relates to the method of aspect 12, wherein the copper-containing material is cuprous oxide and/or cupric oxide.

A fourteenth aspect relates to the method of any one of aspects 11 to 13, wherein the additive compound is a compound of formulae (I), (II), (III), (IV), (V), (VI), or (VII):

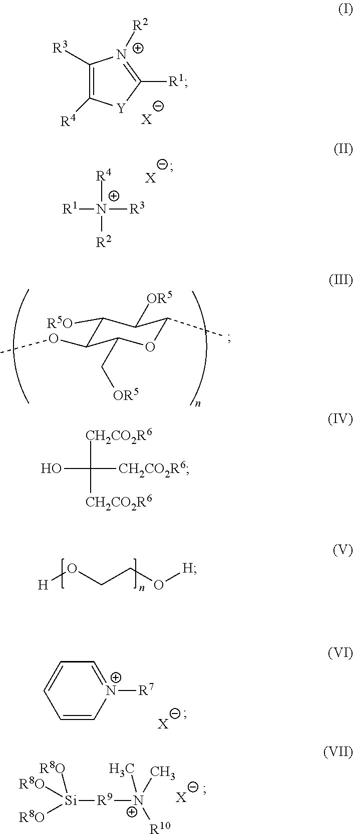

wherein X⁻ is selected from the group consisting of fluoride, chloride, bromide, iodide, hexafluorophosphate, sulfate, trifluoromethanesulfonate, an alkylsulfonate, and an arylsulfonate;
Y is selected from the group consisting of S, S(O), SO₂, NR¹, and PR¹;
each of R¹, R², R³, and R⁴ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl;
the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenoxy, (C₂-C₃₀)alkynyl, (C₂-C₃₀)alkynyl, (C₂-C₃₀)alkynoxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy
R⁵ is selected from the group consisting of hydrogen, (C₁-C₃₀)alkyl, aryl, —CH₂CH₂OH, and —CH₂Co₂H;
the molecular weight of the compound of formula (III) is from 5000 g/mole to 1·10⁶ g/mole;
each R⁶ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl;
the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocylyloxy, aryl(C₁-C₄)alkyl, aryl(C₁-C₄)alkoxy, heteroaryl(C₁-C₄)alkyl, hetero(C₁-C₄)alkoxy, heterocyclyl(C₁-C₄)alkyl, and heterocyclyl(C₁-C₄)alkoxy;
the molecular weight of the compound of formula (V) is from 1000 g/mole to 50000 g/mole;
R⁷ is selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl;
each R⁸ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl;
from Si to N, R⁹ is selected form the group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclylene, and (C₁-C₄)alkylheterocyclyl(C₁-C₄)alkylene; and
R¹⁰ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl.

A fifteenth aspect relates to the method of any one of aspects 11 to 14, wherein the additive compound is selected from the group consisting of 1-butyl-3-methylimidazolium bromide, didecyldimethyl ammonium chloride, hydroxyethyl cellulose, carboxymethyl cellulose, triethyl citrate, 1-cetylpyridinium chloride, N-octadecyldimethyl-(3-(trimethoxysilyl)propyl)ammonium chloride, N-[3-(Trimethoxysilyl)propyl]-N,N,N-trimethylammonium chloride, 4-(trimethoxysilylethyl)benzyltrimethylammonium chloride, and a benzalkonium chloride of the formula:

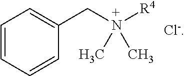

A sixteenth aspect relates to the method of any one of aspects 11 to 15, wherein the thermo- or UV-curable resin is selected from the group consisting of polyacrylate, polyurea, polyurethane, aliphatic and aromatic urethanes, polyurea/polyurethane hybrids, urea-formaldehyde foam, diallylphthalate, polyimide, polyamide, bismaleimides, polyolefin, polystyrene, polycarbonate, polyethylene terephthalate, polybutylene terephthalate, polyvinyl chloride, acrylonitrile butadiene styrene, benzoxazines, fluoropolymers, epoxy, phenolic resins, benzoxazines hybridized with epoxy and phenolic resins, melamine resins, polyesters, silicone resins, cyanate esters or polycyanurates, furan resins, vinyl ester resins, monomers thereof, oligomers thereof, polymers thereof, and any combination or blend thereof.

In addition to the features mentioned in each of the independent aspects enumerated above, some examples may show, alone or in combination, the optional features mentioned in the dependent aspects and/or as disclosed in the description above and shown in the figures.

1. An antimicrobial thermoset coating formulation, comprising:
a copper-containing material in an amount from up to 0.1 to 30 weight %;
an additive compound in an amount from up to 0.1 to 20 weight %; and
a thermo- or UV-curable resin in an amount to total 100 weight % for the formulation.

2. The formulation of claim 1, wherein the copper-containing material is cuprous oxide and/or cupric oxide.

3. The formulation of claim 1, wherein the additive compound is a compound of formulae (I), (II), (III), (IV), (V), (VI), or (VII): 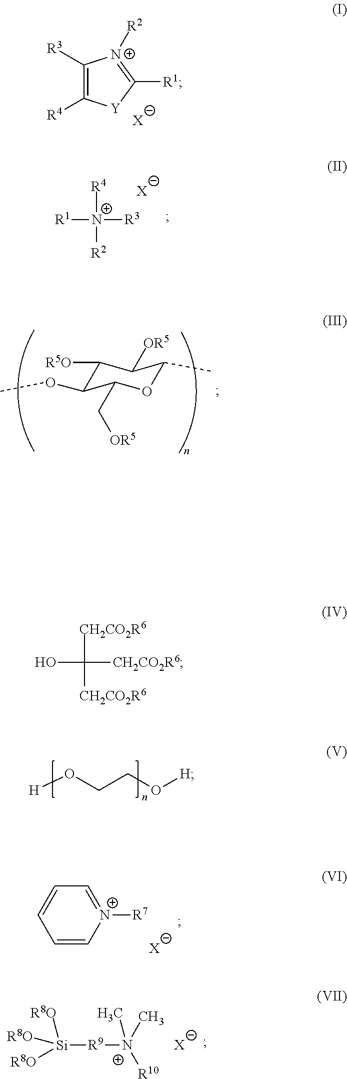
wherein X⁻ is selected from the group consisting of fluoride, chloride, bromide, iodide, hexafluorophosphate, sulfate, trifluoromethanesulfonate, an alkylsulfonate, and an arylsulfonate;
Y is selected from the group consisting of S, S(O), SO₂, NR¹, and PR¹;
each of R¹, R², R³, and R⁴ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl;
the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenoxy, (C₂-C₃₀)alkynyl, (C₂-C₃₀)alkynyl, (C₂-C₃₀)alkynoxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy
R⁵ is selected from the group consisting of hydrogen, (C₁-C₃₀)alkyl, aryl, —CH₂CH₂OH, and —CH₂Co₂H;
the molecular weight of the compound of formula (III) is from 5000 g/mole to 1·10⁶ g/mole;
each R⁶ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl;
the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocylyloxy, aryl(C₁-C₄)alkyl, aryl(C₁-C₄)alkoxy, heteroaryl(C₁-C₄)alkyl, hetero(C₁-C₄)alkoxy, heterocyclyl(C₁-C₄)alkyl, and heterocyclyl(C₁-C₄)alkoxy;
the molecular weight of the compound of formula (V) is from 1000 g/mole to 50000 g/mole:
R⁷ is selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl;
each R⁸ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl;
from Si to N, R⁹ is selected from the group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclylene, and (C₁-C₄)alkylheterocyclyl(C₁-C₄)alkylene; and
R¹⁰ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl.

4. The formulation of claim 3, wherein the additive compound is 1-butyl-3-methylimidazolium bromide, didecyldimethyl ammonium chloride, and/or 1-cetylpyridinium chloride.

5. The formulation of claim 3, wherein the additive compound is hydroxyethyl cellulose and/or carboxymethyl cellulose.

6. The formulation of claim 3, wherein the additive compound is triethyl citrate.

7. The formulation of claim 3, wherein the additive compound is N-octadecyldimethyl-(3-(trimethoxysilyl)propyl)ammonium chloride, 4-(trimethoxysilylethyl)benzyltrimethylammonium chloride, and/or N-[3-(Trimethoxysilyl)propyl]-N,N,N-trimethylammonium chloride.

8. The formulation of claim 3, wherein the additive compound is a benzalkonium chloride of the formula:

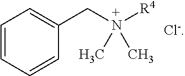

9. The formulation of claim 1, wherein the thermo- or UV-curable resin is selected from the group consisting of polyacrylate, polyurea, polyurethane, aliphatic and aromatic urethanes, polyurea/polyurethane hybrids, urea-formaldehyde foam, diallylphthalate, polyimide, polyamide, bismaleimides, polyolefin, polystyrene, polycarbonate, polyethylene terephthalate, polybutylene terephthalate, polyvinyl chloride, acrylonitrile butadiene styrene, benzoxazines, fluoropolymers, epoxy, phenolic resins, benzoxazines hybridized with epoxy and phenolic resins, melamine resins, polyesters, silicone resins, cyanate esters or polycyanurates, furan resins, vinyl ester resins, monomers thereof, oligomers thereof, polymers thereof, and any combination or blend thereof.

10. A method of preparing an antimicrobial thermoset coating formulation, comprising:
adding from up to 0.1 to 20 weight % of an additive compound to a thermo- or UV-curable resin in an amount to total 100 weight % for the formulation to provide a dispersion;
agitating the dispersion;
applying the dispersion to a surface of a substrate until the dispersion coats the surface of the substrate; and
curing the film with a UV lamp to provide the antimicrobial thermoset coating formulation.

11. The method of claim 10, further comprising:
adding a copper-containing material in an amount from up to 0.1 to 30 weight % to the thermo- or UV-curable resin prior to the adding of the additive compound.

12. The method of claim 11, wherein the copper-containing material is cuprous oxide and/or cupric oxide.

13. The method of claim 10, wherein the additive compound is a compound of formulae (I), (II), (III), (IV), (V), (VI), or (VII): 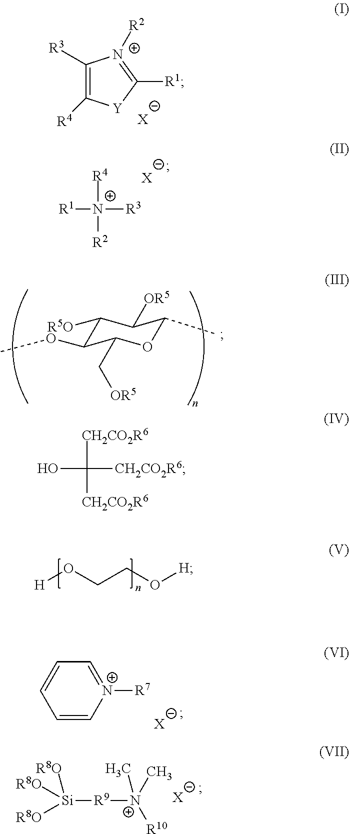
wherein X⁻ is selected from the group consisting of fluoride, chloride, bromide, iodide, hexafluorophosphate, sulfate, trifluoromethanesulfonate, an alkylsulfonate, and an arylsulfonate;
Y is selected from the group consisting of S, S(O), SO₂, NR¹, and PR¹;
each of R¹, R², R³, and R⁴ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl;
the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenoxy, (C₂-C₃₀)alkynyl, (C₂-C₃₀)alkynyl, (C₂-C₃₀)alkynoxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy
R⁵ is selected from the group consisting of hydrogen, (C₁-C₃₀)alkyl, aryl, —CH₂CH₂OH, and —CH₂Co₂H;
the molecular weight of the compound of formula (III) is from 5000 g/mole to 1·10⁶ g/mole;
each R⁶ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and a substituted silyl;
the substituted silyl is substituted with three substituents each independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocylyloxy, aryl(C₁-C₄)alkyl, aryl(C₁-C₄)alkoxy, heteroaryl(C₁-C₄)alkyl, hetero(C₁-C₄)alkoxy, heterocyclyl(C₁-C₄)alkyl, and heterocyclyl(C₁-C₄)alkoxy;
the molecular weight of the compound of formula (V) is from 1000 g/mole to 50000 g/mole;
R⁷ is selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl;
each R⁸ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, heterocyclyl(C₁-C₄)alkyl, and a substituted silyl;
from Si to N, R⁹ is selected form the group consisting of (C₁-C₃₀)alkylene, (C₂-C₃₀)alkenylene, (C₂-C₃₀)alkynylene, aryl(C₁-C₄)alkylene, (C₁-C₄)alkylarylene, (C₁-C₄)alkylaryl(C₁-C₄)alkylene, heteroaryl(C₁-C₄)alkylene, (C₁-C₄)alkylheteroarylene, (C₁-C₄)alkylheteroaryl(C₁-C₄)alkylene, heterocyclyl(C₁-C₄)alkylene, (C₁-C₄)alkylheterocyclylene, and (C₁-C₄)alkylheterocyclyl(C₁-C₄)alkylene; and
R¹⁰ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl.

14. The method of claim 10, wherein the additive compound is selected from the group consisting of 1-butyl-3-methylimidazolium bromide, didecyldimethyl ammonium chloride, hydroxyethyl cellulose, carboxymethyl cellulose, triethyl citrate, 1-cetylpyridinium chloride, N-octadecyldimethyl-(3-(trimethoxysilyl)propyl)ammonium chloride, N-[3-(Trimethoxysilyl)propyl]-N,N,N-trimethylammonium chloride, 4-(trimethoxysilylethyl)benzyltrimethylammonium chloride, and a benzalkonium chloride of the formula:

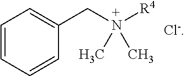

15. The method of claim 10, wherein the thermo- or UV-curable resin is selected from the group consisting of polyacrylate, polyurea, polyurethane, aliphatic and aromatic urethanes, polyurea/polyurethane hybrids, urea-formaldehyde foam, diallylphthalate, polyimide, polyamide, bismaleimides, polyolefin, polystyrene, polycarbonate, polyethylene terephthalate, polybutylene terephthalate, polyvinyl chloride, acrylonitrile butadiene styrene, benzoxazines, fluoropolymers, epoxy, phenolic resins, benzoxazines hybridized with epoxy and phenolic resins, melamine resins, polyesters, silicone resins, cyanate esters or polycyanurates, furan resins, vinyl ester resins, monomers thereof, oligomers thereof, polymers thereof, and any combination or blend thereof.

16. An antimicrobial system, comprising:
a reservoir comprising a dispersion of an antimicrobial thermoset coating formulation;
a disperser fluidly connected to the reservoir configured to apply the antimicrobial thermoset coating formulation to a surface; and
a heat or ultraviolet radiation source configured to cure the antimicrobial thermoset coating formulation after the antimicrobial thermoset coating formulation is applied to the surface;
wherein the antimicrobial thermoset coating formulation comprises: an additive compound in an amount from up to 0.1 to 20 weight %; a copper-containing material in an amount from up to 0.1 to 30 weight %; and a thermo- or UV-curable resin in an amount to total 100 weight % for the formulation.

17.-20. (canceled)

21. The formulation of claim 3, wherein the additive compound is a compound of formula (I): 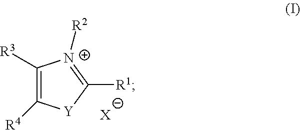
wherein:
R² is (C₁-C₃M)alkyl;
Y is NR¹, wherein NR¹ is N—(C₁-C₃₀)alkyl; and
X⁻ is selected from the group consisting of fluoride, chloride, bromide, and iodide.

22. The formulation of claim 21, wherein, in formula (I):
each of R¹, R³, and R⁴ is hydrogen;
R² is methyl;
Y is NR¹, wherein NR¹ is ethyl; and
X⁻ is chloride.

23. The method of claim 13, wherein the additive compound is a compound of formula (I): 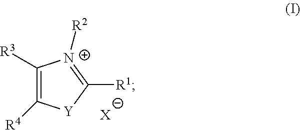
wherein:
each of R, R³, and R⁴ is hydrogen;
R² is (C₁-C₃₀)alkyl;
Y is NR¹, wherein NR¹ is N—(C₁-C₃₀)alkyl; and
X⁻ is selected from the group consisting of fluoride, chloride, bromide, and iodide.

24. The method of claim 23, wherein, in formula (I):
each of R¹, R³, and R⁴ is hydrogen;
R² is methyl;
Y is NR¹, wherein NR¹ is N-ethyl; and
X⁻ is chloride.
